(19) United States
(12) Patent Application Publication
(10) Pub. No.: US 2019/0208705 A1
(43) Pub. Date: Jul. 11, 2019

(54) HARVESTING ROBOT FOR HARVESTING TREE FRUITS

(71) Applicant: Pierluigi PIPPI, Bäch (CH)

(72) Inventor: Pierluigi PIPPI, Bäch (CH)

(21) Appl. No.: 16/099,168

(22) PCT Filed: May 5, 2017
(86) PCT No.: PCT/EP2017/060827

§ 371 Date: Nov. 5, 2018

(30) Foreign Application Priority Data
May 6, 2016 (CH) 00599/16

(51) Int. Cl. A01D 46/253

(52) U.S. Cl. CPC A01D 46/253

(57) ABSTRACT

The harvesting robot is used to pick fruits from trees. It has at least two parallel extending, and vertically offset, rows of harvesting rods which are kept in their rear region in a holder, and can be pushed collectively into a tree with their free front ends. With their front ends, they can be pivoted. In each pivoted state, they can be withdrawn collectively from the tree with their support while removing the fruits between the harvesting rods from the two rows of harvesting rods. The individual harvesting rods are mounted in their rear region in the holder so as to be elastically moveable by means of spring force. Once all the harvesting rods have collectively been withdrawn with the harvested fruits in between, all of the harvesting rods are pushed forward again by the force of the acting spring forces and are thus returned to their original positions.

This invention is a harvesting robot for efficiently and gently picking fruits from trees, especially olives or nuts. The harvesting of olive trees, for example, but also of nut trees, is still done in most cases by hand. Especially in the case of old olive trees on hilly terrain, mechanical harvesting is possible only in a limited manner, or at best by using semi-automatic tools to complement manual harvesting. It is a very time-consuming and strenuous task which incurs high personnel costs. To ensure that the olives are of a high quality, the fruits should be harvested when they are ripe but not overripe. When harvesting is done with common mechanical aids, the bark is often damaged, which can have a negative impact on crop yields in the following years.

There are certain harvesting machines, for example, the Olive Harvester OXBO 6420 made by OXBO from Lynden, Wash. 98264 (www.oxbocorp.com). This machine is designed to run lengthways over a row of olive bushes. It strips the olives with relatively invasive interventions from both sides of the tree, with harvesting rods rotating around vertical axes and projecting radially from these axes, which are swung through the branches of the tree. The machine is certainly efficient but can only be used on more or less level ground for the harvesting of olive bushes or olive trees which are precisely arranged in a row. This machine cannot be used on irregularly shaped fields, and especially not for old and thus relatively large olive trees, which are planted in an area in an irregular pattern.

Another state of the art technology is described in EP 2 566 317 B1, which moves two rows of prongs against each other. This mechanism is based on a rotational movement which is converted into a swinging motion. The device is mounted on a support device which is driven into the tree. AU 2010 257 276 A1 is another device for harvesting olives. A cubic frame is slipped over a tree and rotated around the axis of the tree trunk. Prongs protrude into the tree at different heights, where they can be swung back and forth horizontally. WO 2003 069 975 A1 shows another automatic harvesting machine. Two semi-circular frames are driven around a tree, on both sides, and swung together. The prongs protrude from the semi-circular frame into the tree and can be swung up and down and moved back and forth. In principle, such devices operate through prongs or rods that swing against each other and thereby are slowly pulled out of the tree. Finally, U.S. Pat. No. 4,377,064 shows rods that are spring-loaded in the longitudinal direction and pushed longitudinally into a tree, and press or push larger fruits away from the tree with their tips. If a rod is entering the tree and thereby strikes a branch with its tip, the rod support continues to enter the tree while the rod is pushed against a spring force, back into the support remaining stationary in relation to the tree. The fruits are taken off the tree with the rubber-reinforced tip of the rods. The rods are not pivoted, but rather only moved linearly and are not very effective for relatively small fruits such as olives.

None of the equipment known so far is suitable for the gentle and efficient harvesting of olive trees or nut trees on hilly terrain, especially when the trees are old and have therefore grown large, when the trees are planted on irregularly shaped fields, and when their shape is not particularly symmetrical. In Europe, for example, olive trees are mostly planted on large old olive groves, often on rugged terrain, and the trees are usually very old, sometimes several hundred years old. Olive groves are also protected in many areas. So far, such olive trees can only be harvested by hand, but produce olives of genuinely high quality.

Given the current state of the art, the aim of this invention is to produce a harvesting robot for picking fruits from trees, enabling the rapid, efficient, cost-effective and gentle picking of fruits from trees, that can also be used on hilly terrain. The harvesting robot should be particularly suitable for harvesting olives from olive trees, even if they are irregularly planted, including large and old trees on sloped terrain. According to one version, the harvesting robot should be attachable to a tractor or to a carrier vehicle for slanted terrain and in a later version be provided with its own off-road chassis, to be used both in a self-steered and remote-controlled manner.

The objective is solved by the creation and operation of a harvesting robot for picking fruits from trees, with at least two mutually parallel, horizontally-projecting and offsetting rows of picking bars held in the back area in a support, which together can be pushed through a tree with their free front ends, which can oscillate up and down and re-open at the same time and can be collectively pulled out of a tree in every possible swiveling position while at the same time picking up the fruits between the two rows of picking rods. The harvesting robot is also characterized by the fact that the individual rows are mounted in the support so as to be transversely moveable against a spring force so each harvesting rod within a row can be stopped by a branch when it drives into a tree and when hit at its front end, while any harvesting rods which do not hit an obstacle are pushed further into the tree. After this, the harvesting rods of the two rows are oscillated back and forth swiveling against each other and simultaneously or subsequently pulled out of the tree backwards through the support, with the harvesting rods pushed forward by the force of the acting springs and brought into their initial position.

One potential version of this harvesting robot is presented in the drawings. The harvesting robot and its functions will be described and clarified below in reference to these drawings:

Indications:

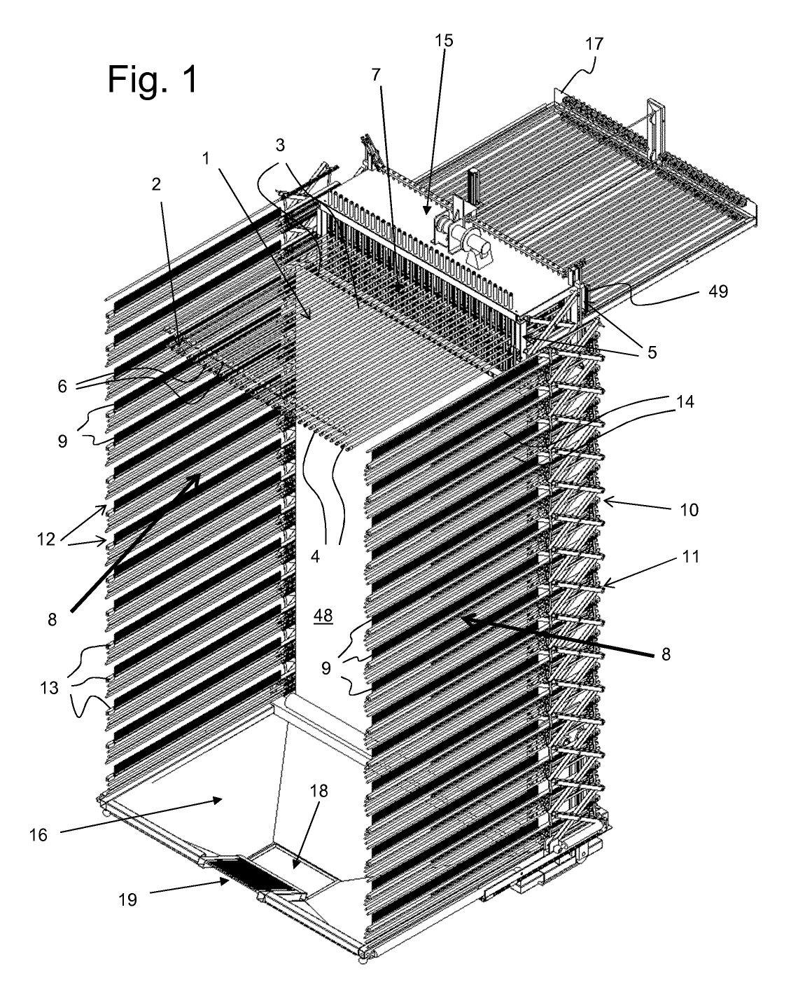

FIG. 1 The harvesting robot seen slanted from the front, while entering the tree for the first time, with the harvesting rods in their upper-most position;

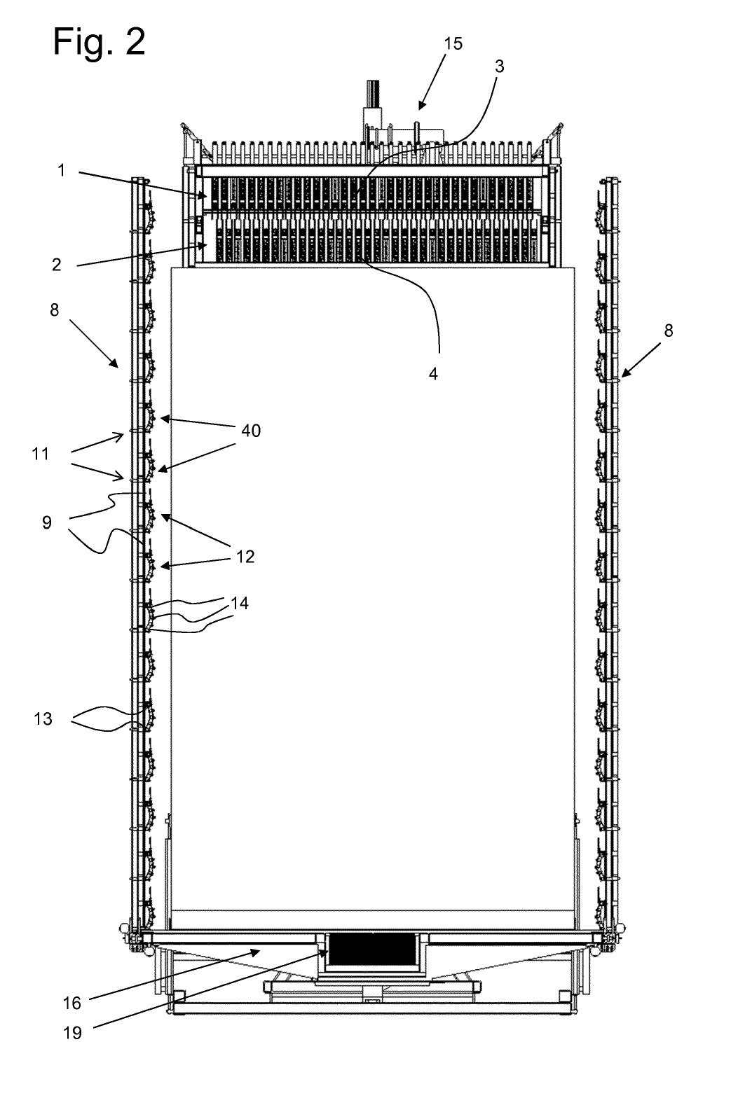

FIG. 2 A view of the harvesting robot seen from the front;

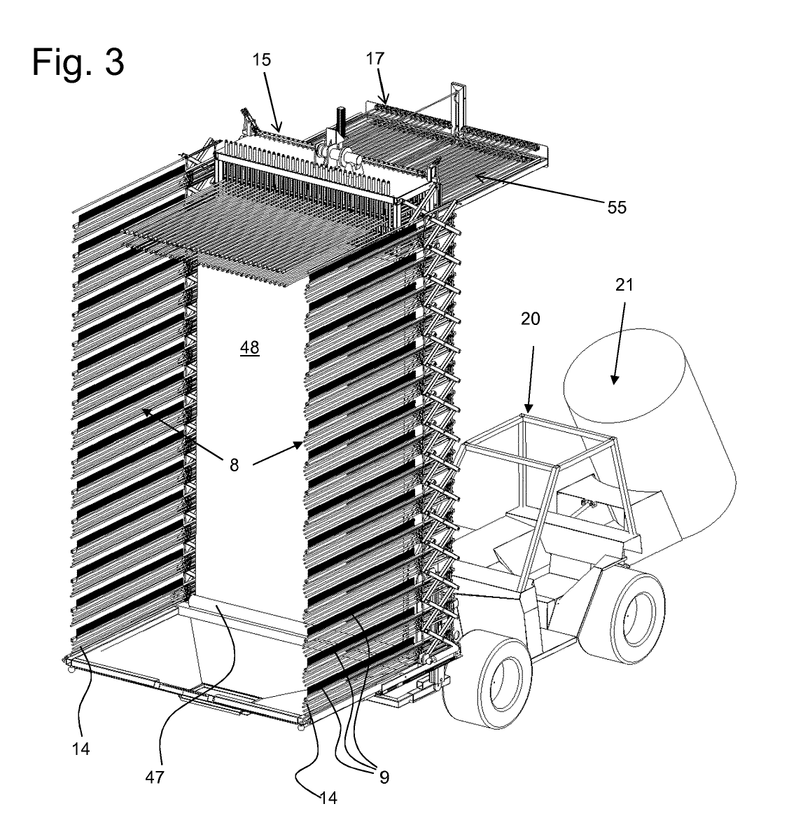

FIG. 3 The harvesting robot seen slanted from the front, while entering the tree for the first time and attached to a carrier vehicle for slanted terrain;

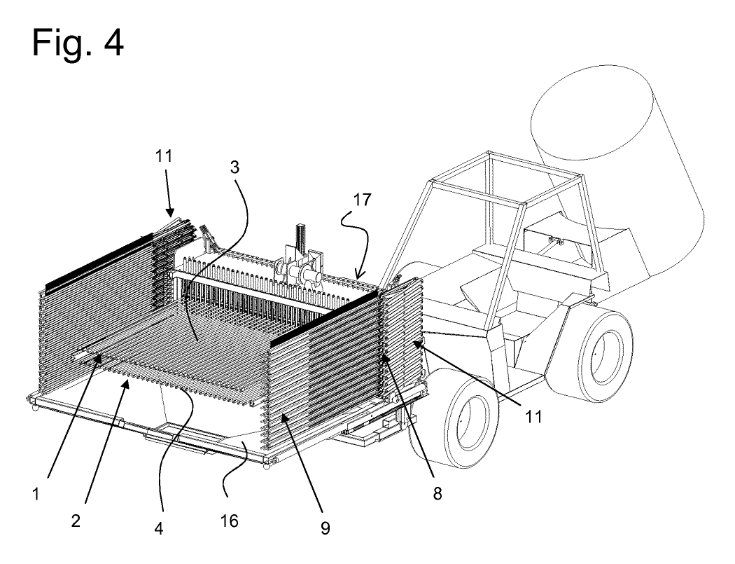

FIG. 4 A view of the harvesting robot seen slanted from the front, with the harvesting equipment folded down to drive on a road;

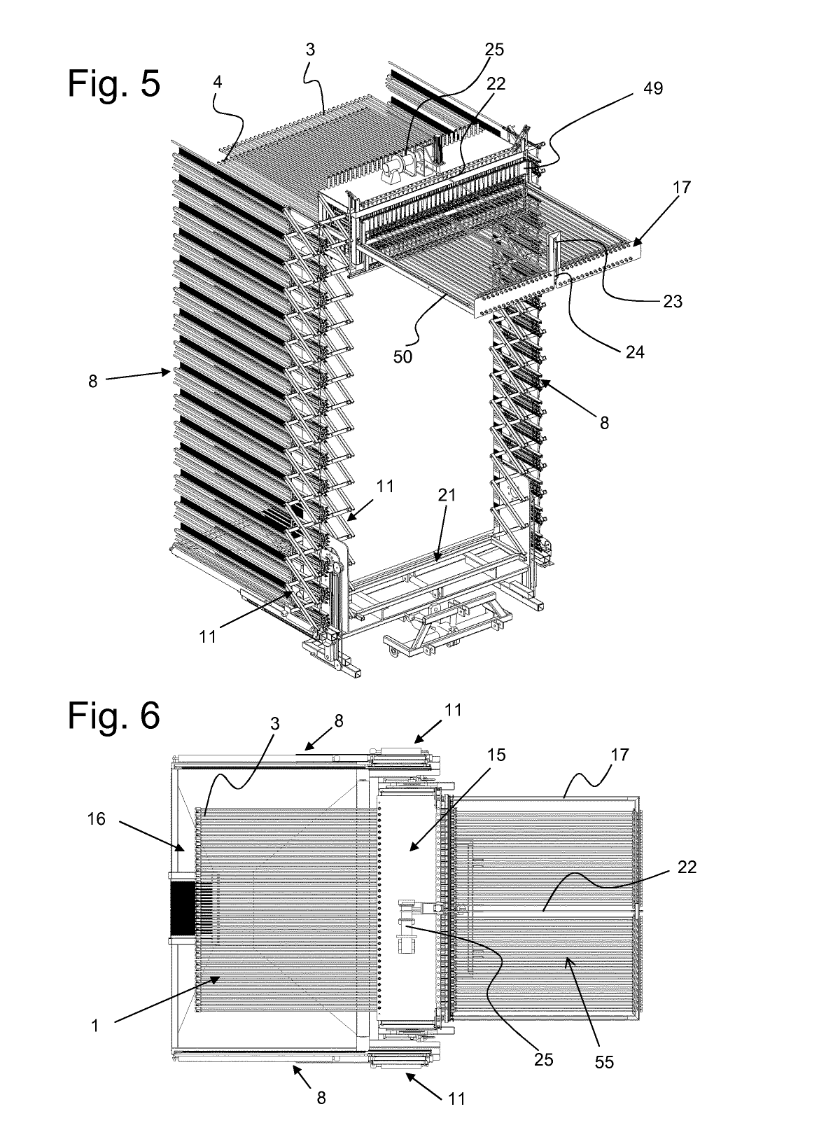

FIG. 5 A view of the harvesting robot slanted from the rear top;

FIG. 6 A view of the harvesting robot from above;

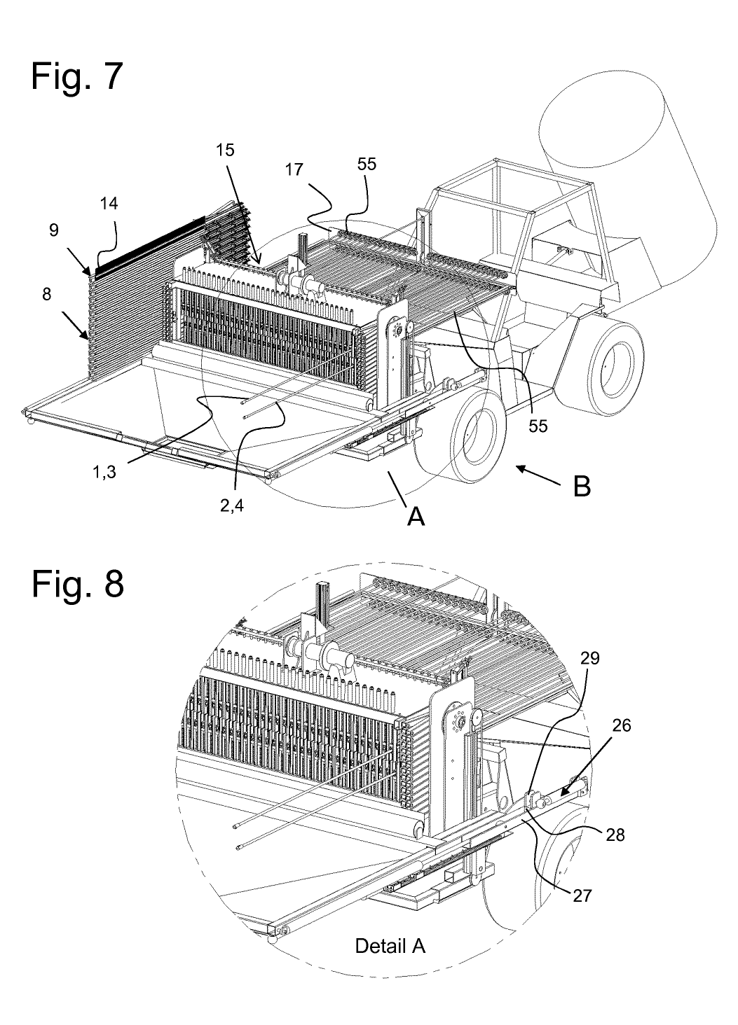

FIG. 7 A view of the harvesting robot slanted from the front and top, with missing, left sidewall and attached to a carrier vehicle for slanted terrain;

FIG. 8 Detail A in FIG. 7, magnified;

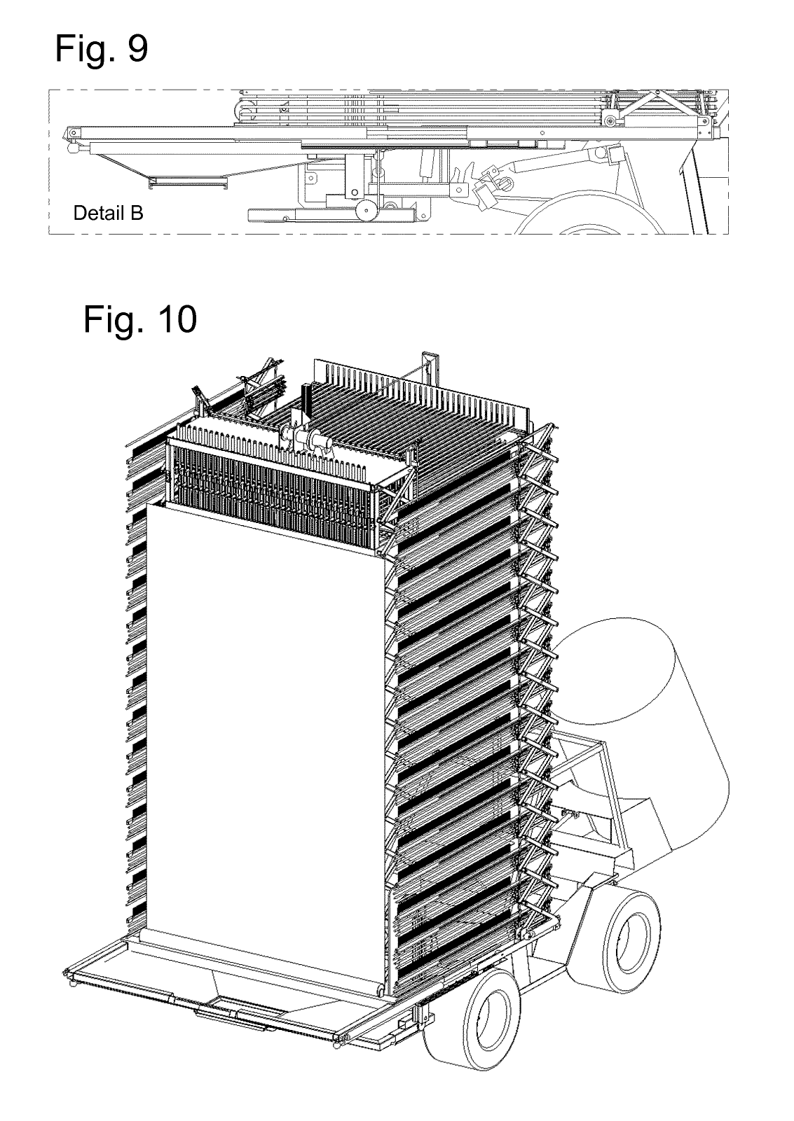

FIG. 9 Detail B in FIG. 7, magnified, focusing from a perpendicular view of the vehicle's side;

FIG. 10 The harvesting robot with retracted harvesting rods, seen from the front;

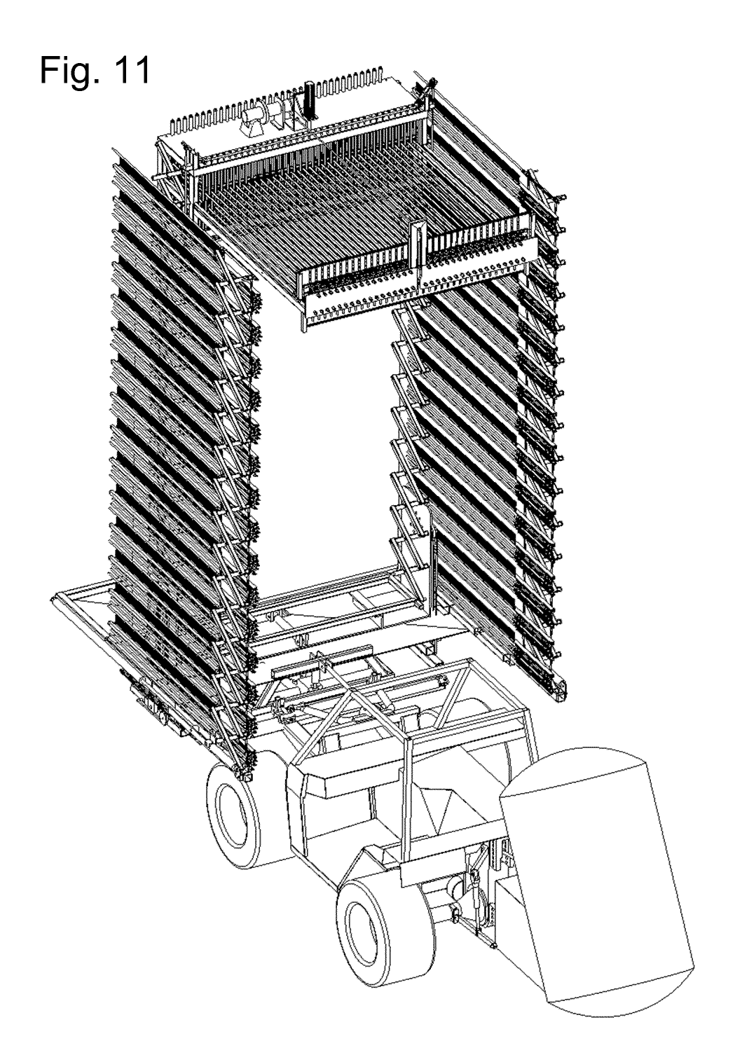

FIG. 11 The harvesting robot with retracted picking rods from a skewed rear view;

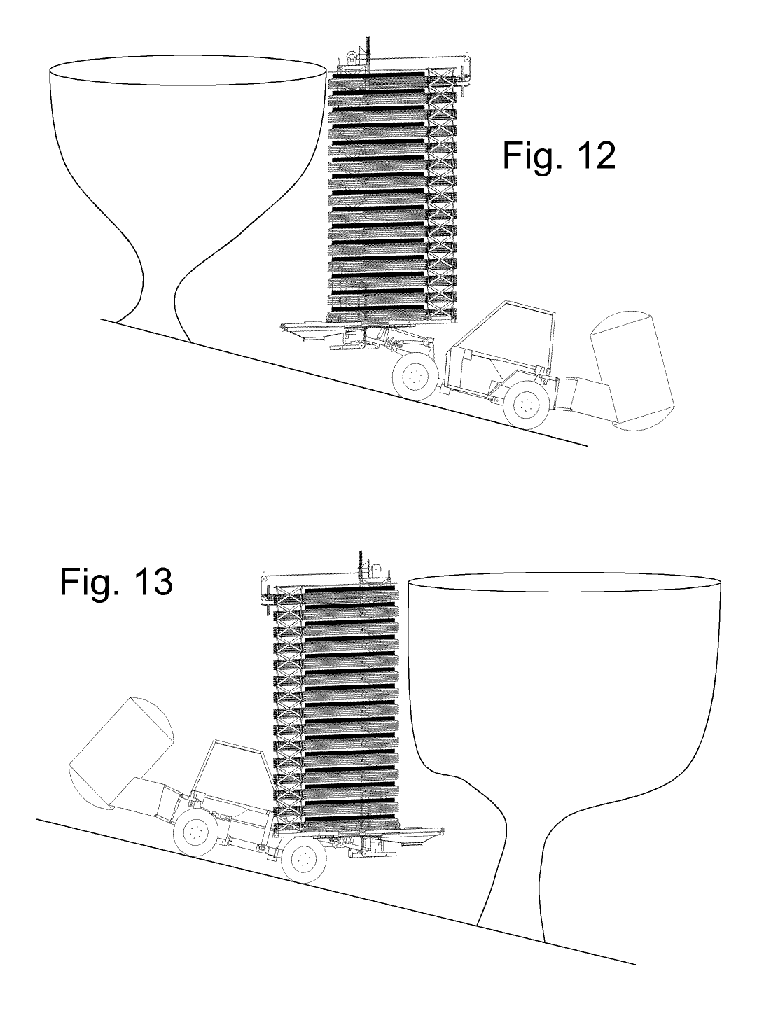

FIG. 12 The harvesting robot with retracted harvesting rods from the left, while approaching on a slope below a tree for harvesting;

FIG. 13 The harvesting robot with retracted harvesting rods in a view from the right side, while approaching on a slope above a tree for harvesting;

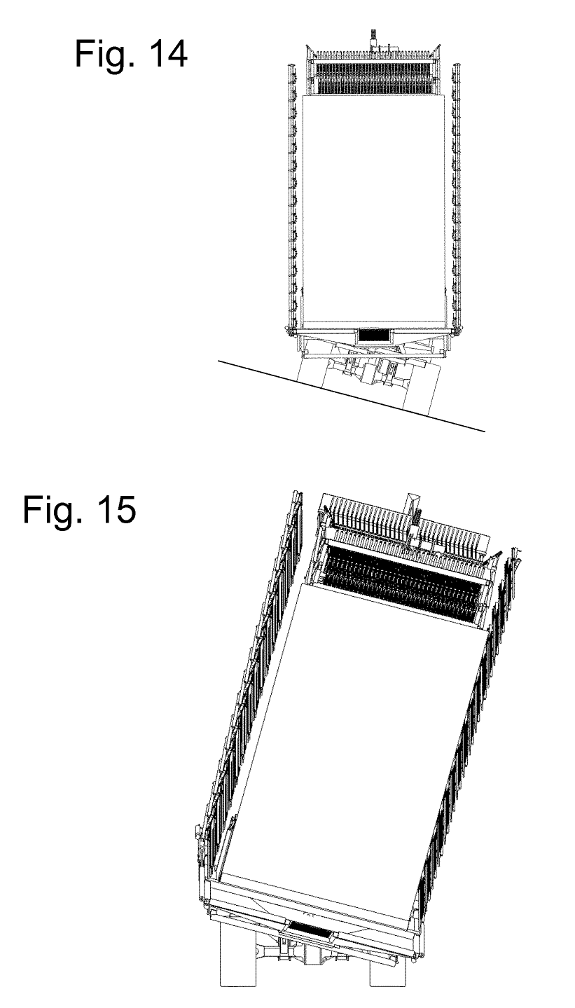

FIG. 14 The harvesting robot with retracted harvesting rods in a view from the front, being driven on a slope towards the tree to be harvested (not shown);

FIG. 15 The harvesting robot with retracted harvesting rods on horizontal ground, while the harvesting head, with all its elements relative to the vehicle, is mounted on the vehicle with a sideways tilt and is leaning towards one side;

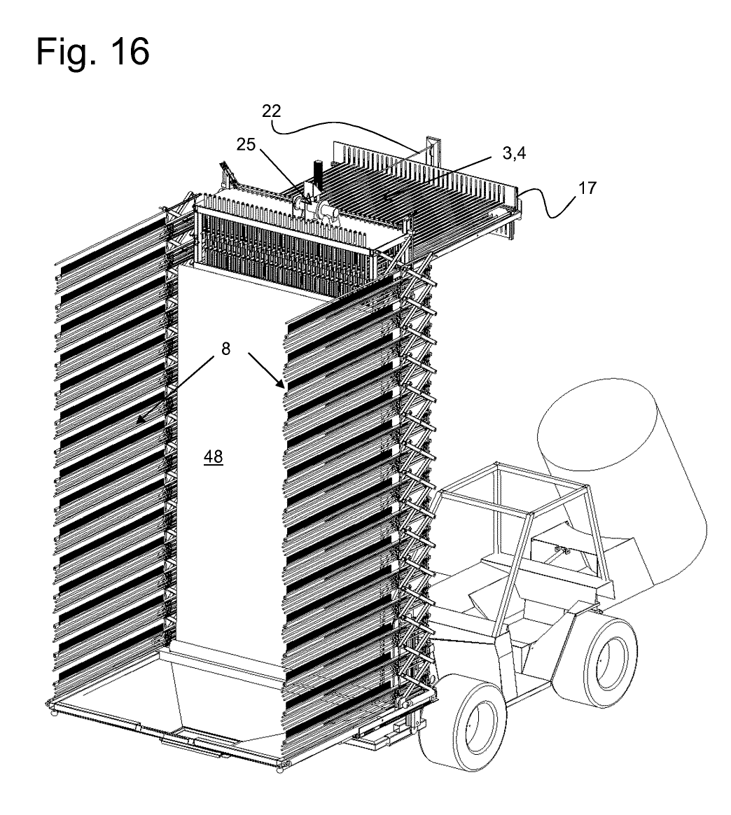

FIG. 16 The harvesting robot as shown in FIG. 3, but with the harvesting rods pushed backwards against the springs;

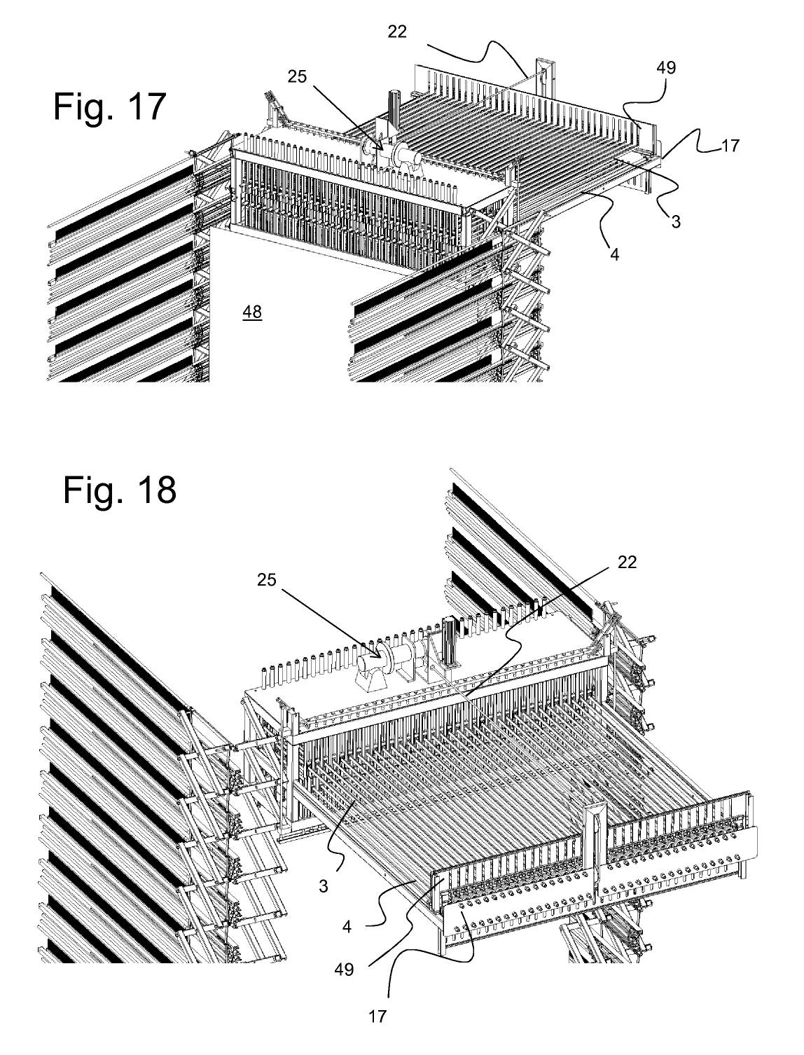

FIG. 17 The harvesting head of the harvesting robot of FIG. 16, magnified, with the harvesting rods pushed backwards;

FIG. 18 The harvesting head of the harvesting robot from FIG. 17 in a magnified, skewed view from the rear and above, with the harvesting rods pushed backwards;

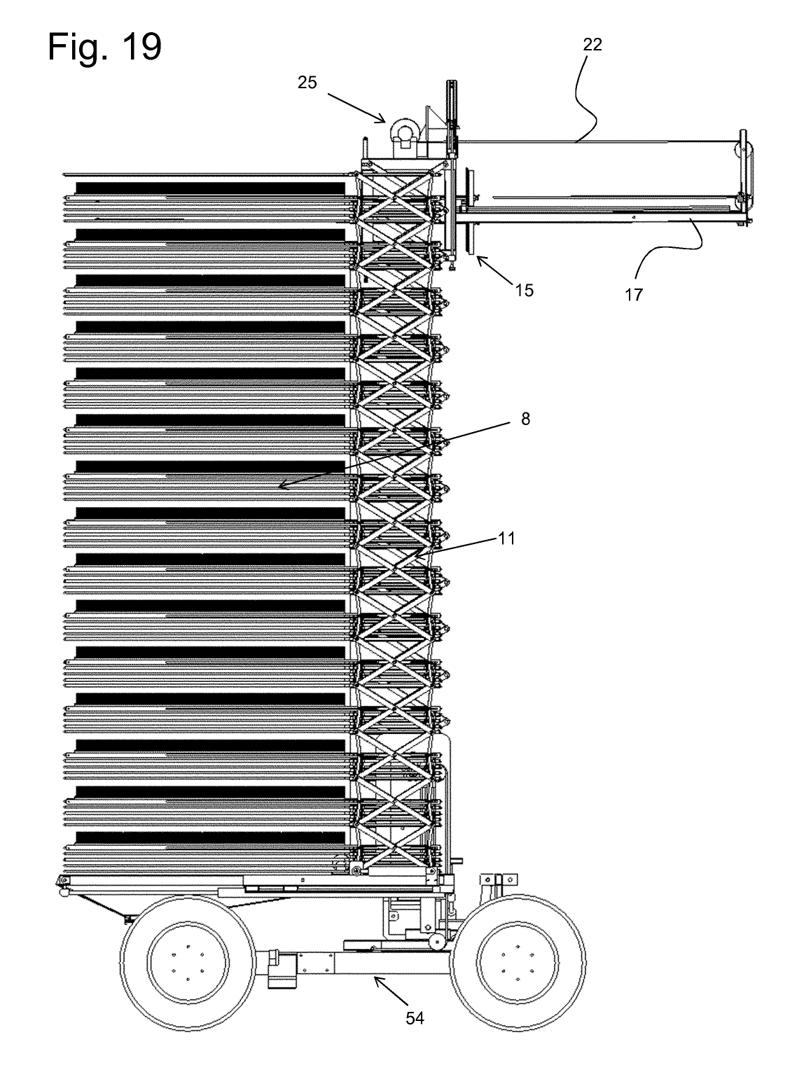

FIG. 19 The harvesting robot, set up on its own chassis, with the harvesting head extended to its uppermost position and the harvesting rods extended to the rear, from the left;

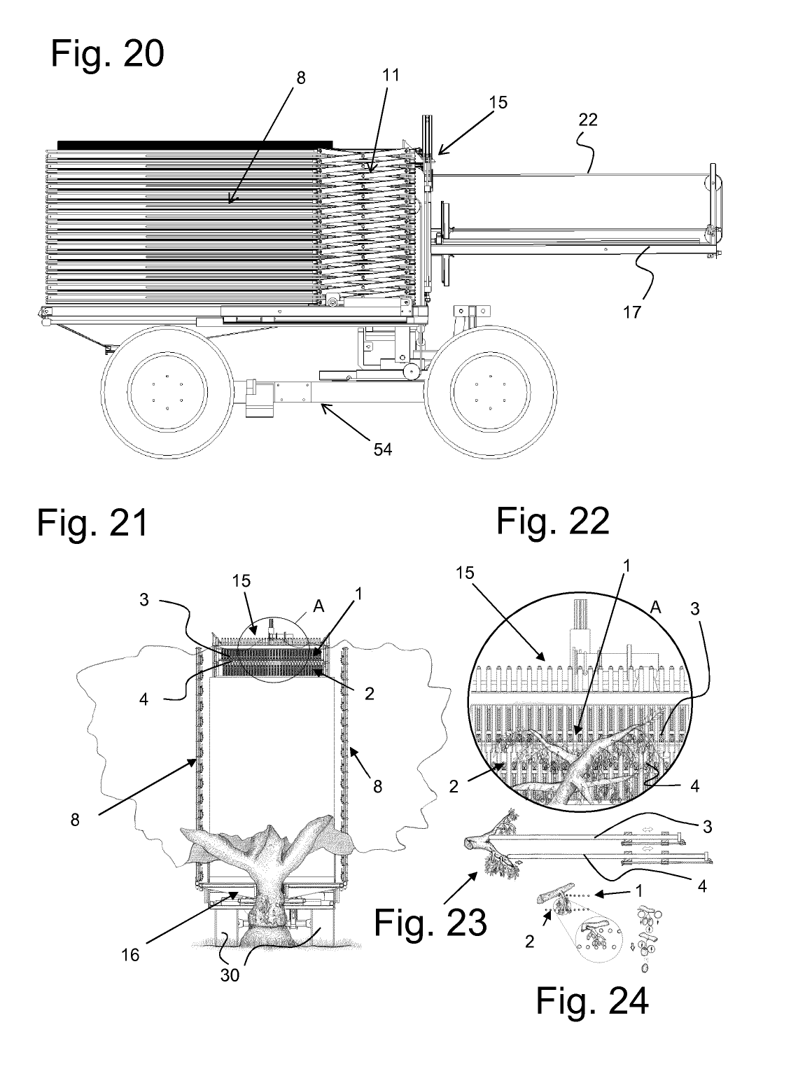

FIG. 20 The harvesting robot seen from the left side, set up on its own chassis, with the harvesting head lowered to its lowest position;

FIG. 21 The harvesting robot approaching an designated olive tree from behind, towards the viewer;

FIG. 22 Detail A in FIG. 21;

FIG. 23 Two stacked harvesting rods seen from the side, each with its tip hitting a branch;

FIG. 24 A view from the front of the front ends of two rows of picking rods, aimed in the direction of the fruits to be harvested;

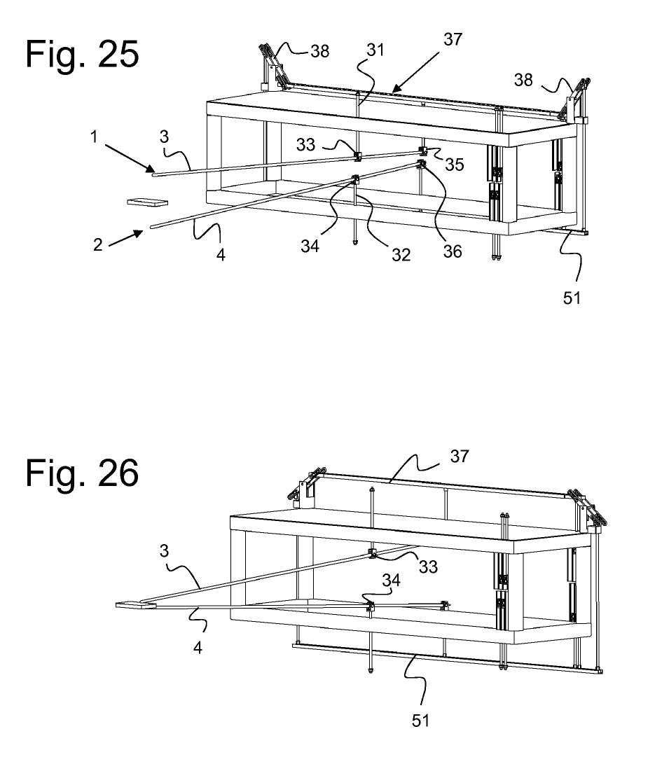

FIG. 25 The harvesting head with only one picking rod each from the upper and lower rows, including their suspension and drive in straddled position from the two harvesting rods;

FIG. 26 The harvesting head with only one harvesting rod each from the upper and lower rows, including their suspension and drive with the two harvesting rods swiveled together when hitting a vertical obstacle;

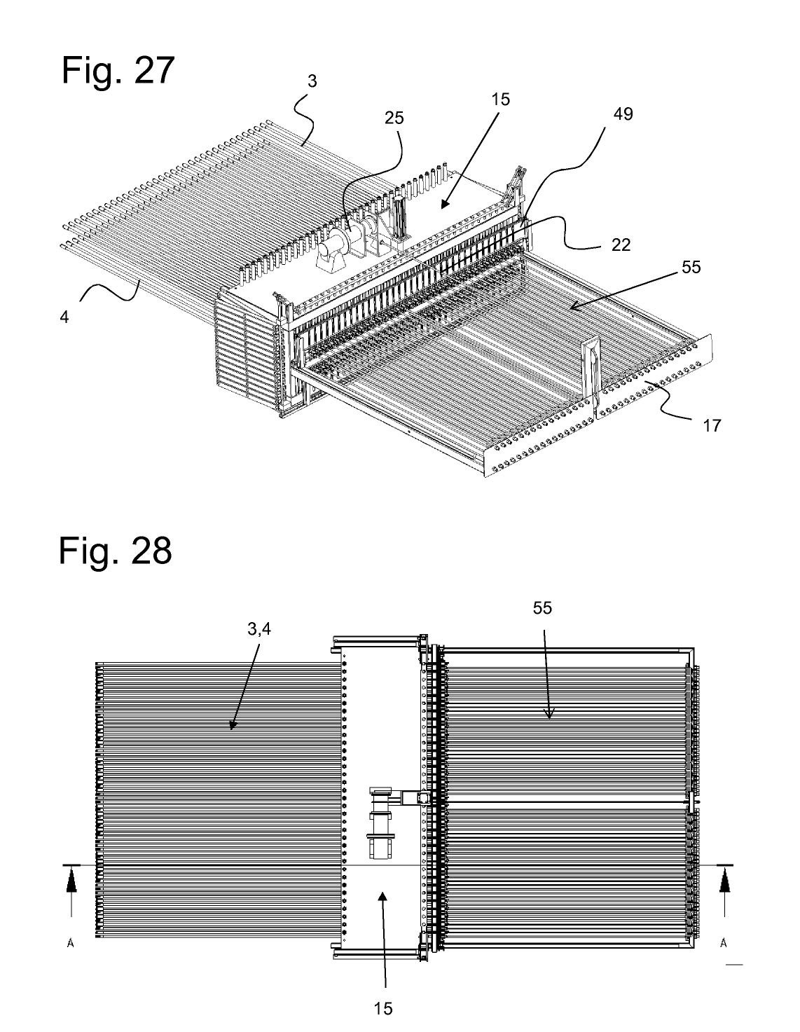

FIG. 27 The harvesting head in a slanted view from the rear-top, with a large number of longitudinally-moveable picking rods and their associated pneumatic hoses;

FIG. 28 The harvesting head seen from above, with a large number of longitudinally-moveable picking rods and their associated pneumatic hoses;

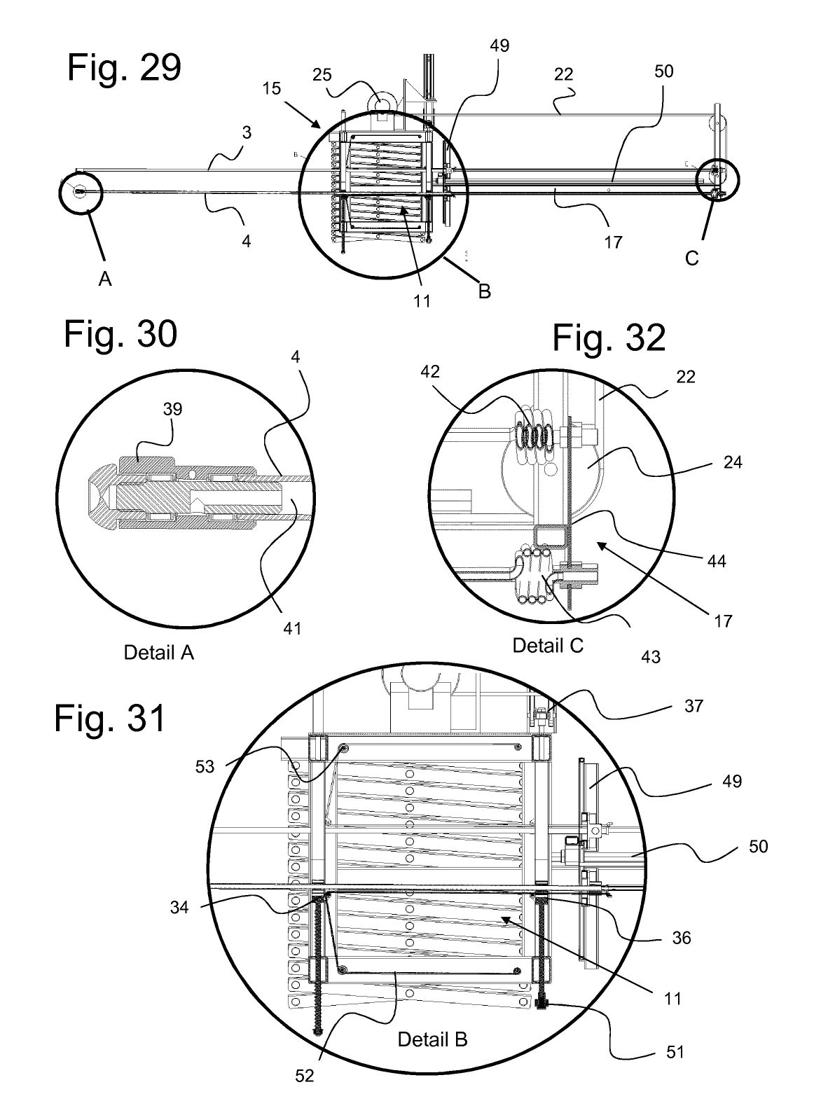

FIG. 29 The harvesting head seen from the side, with a large number of longitudinally-moveable picking rods and their associated pneumatic hoses, in a sectional A-A view of FIG. 28;

FIG. 30 Detail A in FIG. 29;

FIG. 31 Detail B in FIG. 29;

FIG. 32 Detail C in FIG. 29;

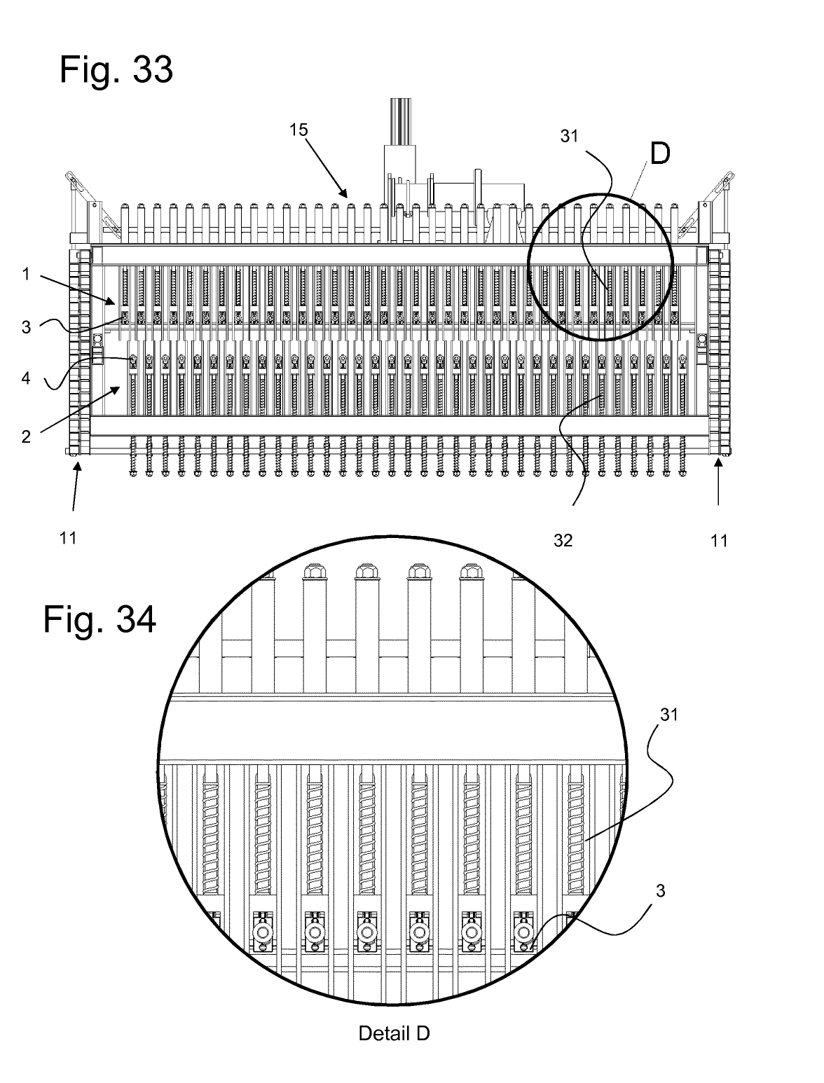

FIG. 33 The harvesting head seen from the front, with a large number of longitudinally-moveable picking rods and their spring suspensions;

FIG. 34 Detail D in FIG. 33;

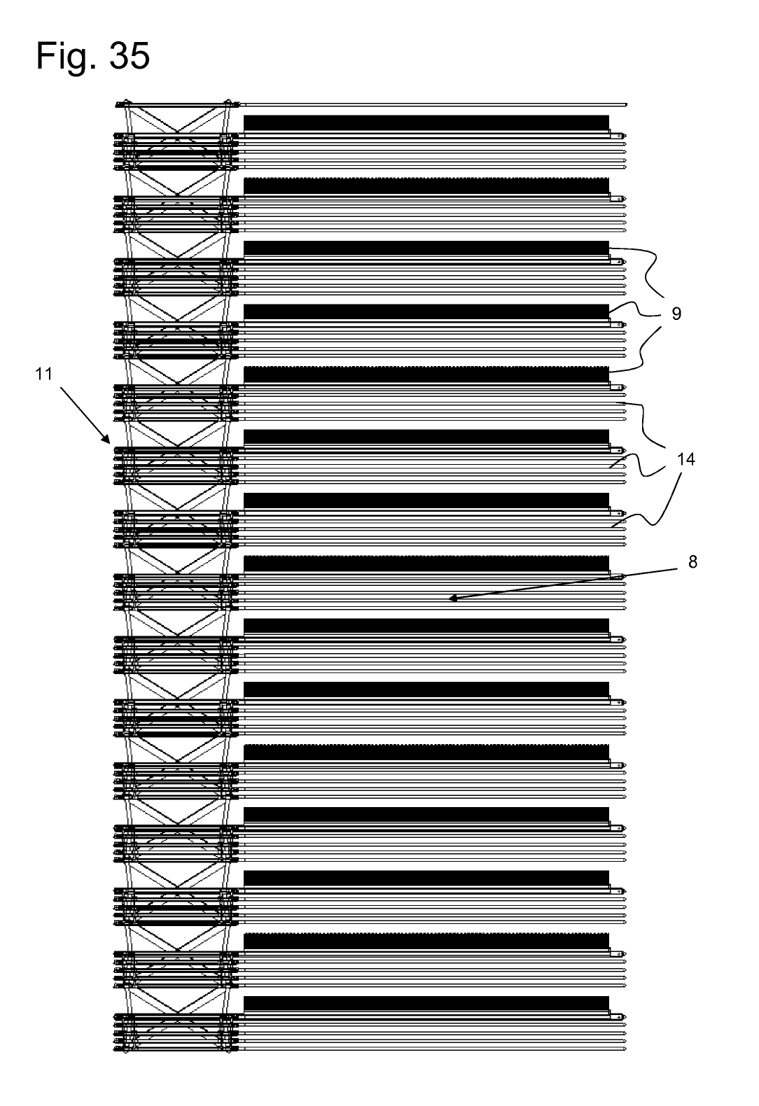

FIG. 35 An internal view of the left sidewall of the harvesting robot in the upwardly-extended state;

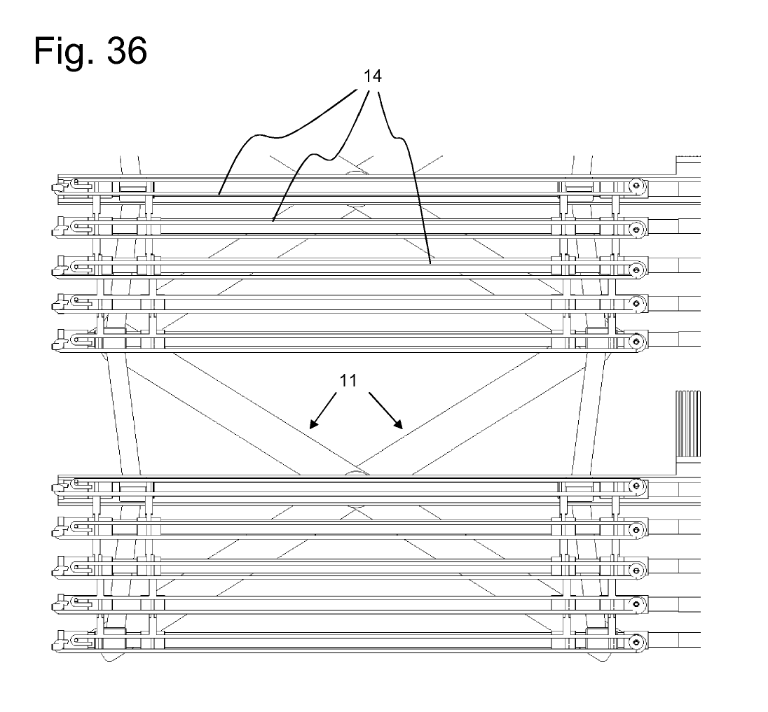

FIG. 36 An internal view of an enlarged section of the left sidewall of the harvesting robot with its scissor construction;

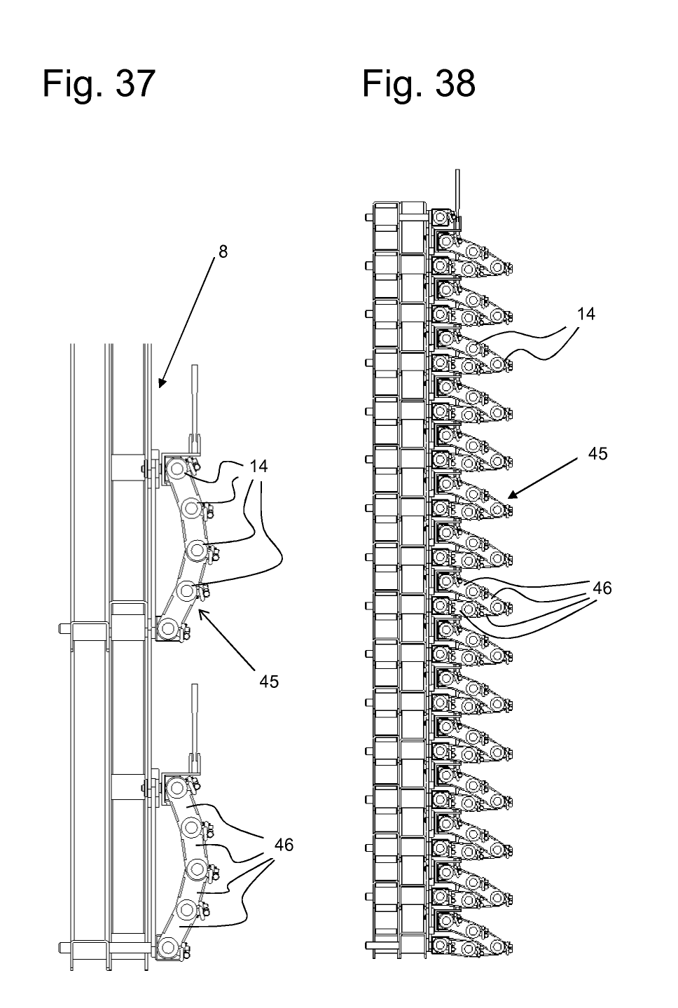

FIG. 37 A section of the left sidewall of the harvesting robot seen from the rear, with the sidewall extended upward;

FIG. 38 The left sidewall of the harvesting robot seen from the rear, in the lowered position;

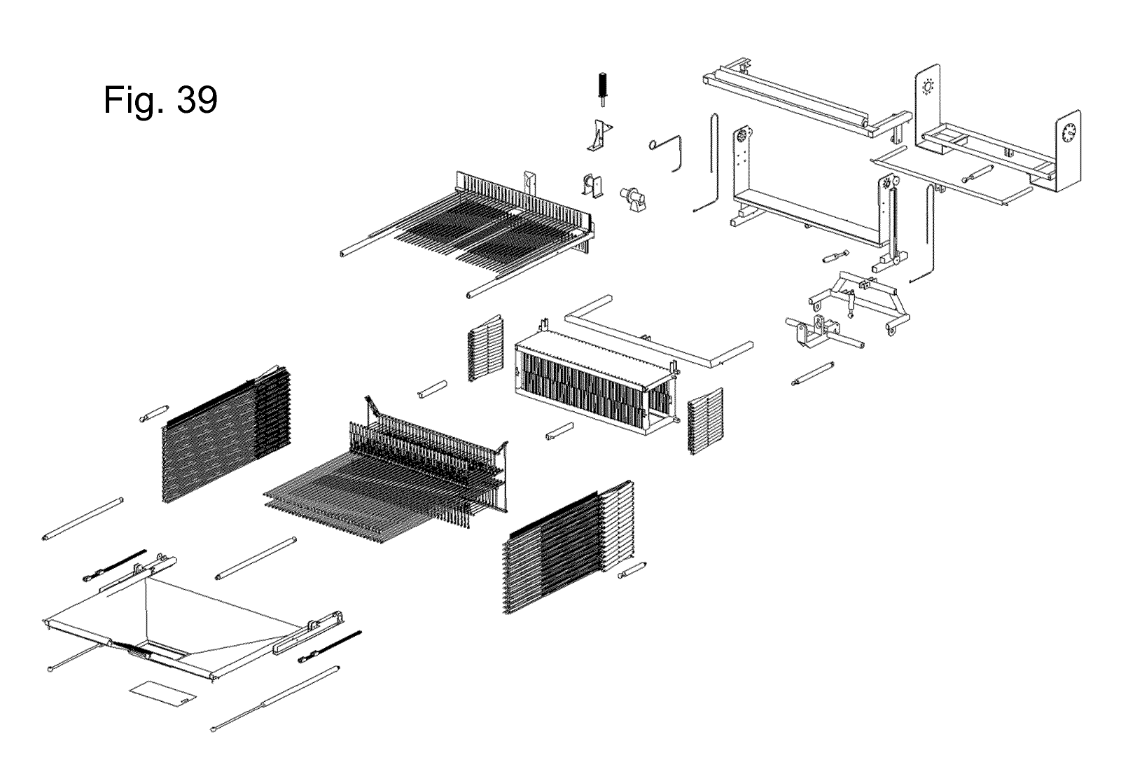

FIG. 39 An exploded drawing of all parts of the machine assembly;

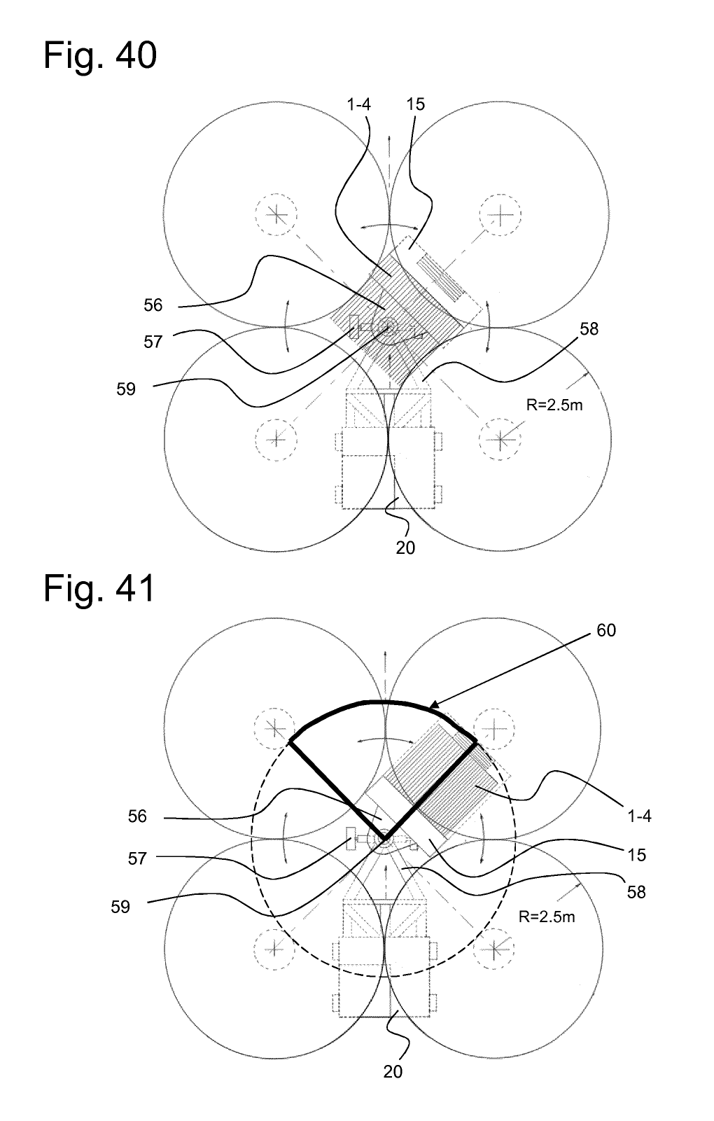

FIG. 40 A group of four trees seen from above after the robot has entered between two trees to harvest the rear tree on the right;

FIG. 41 View from above of the group of four trees seen in FIG. 40, after the robot has entered between two trees and ejected the harvesting rods for harvesting the tree on the rear right;

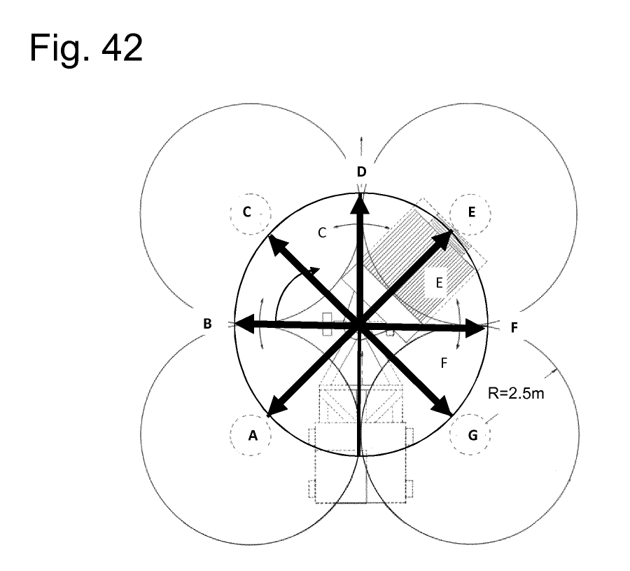

FIG. 42 View from above of the group of four trees seen in FIG. 40, after the robot has entered between two trees and ejected the harvesting rods for harvesting the tree, showing different harvesting strategies;

The harvesting process is as follows: The harvesting robot is driven into a quarter section of the tree to be harvested. Therefore, two sideways and vertically offset rows of rods on their support are driven into the tree. The harvesting head is first driven into the treetop. During the harvesting process it moves from top to bottom. Rods colliding with large branches are retracted backwards in connection with the harvesting head, opposite to the entry direction of the harvesting robot. This prevents damage to the rods and branches. Those bars that do not collide are fully extended into the treetop. Driven by an actuator, the rods are oscillated back and forth in relation to each other, preferably in a vertical up and down oscillation, while the two rows of picking rods lie in two offsetting horizontal levels. In addition, the rods, driven by rotation of an eccentric mass on the rod tip, can pivot around the axis of symmetry. By superimposing the two oscillating planes, the rod tips, depending on the stiffness of the rods and the rotational speed of the eccentric masses, pass through all spatial points in a forward-opening cone and around the rod tips up to the respective height of their plane. By retracting the rods backwards out of the treetop, the rod tips finally go through all the spaces within two rows of rods. Thus, all fruits from the tree that are located between the rows of rods and that collide with the rods are separated from the tree and harvested. Those rods which oscillate and vertically strike a branch are deflected by the resistance given by the branch and through a dedicated mechanical system. This prevents damage to both the rod and branch. Tree fruits which fall to the right, to the left or to the back, are directed by the harvesting robot into a collecting funnel. This guarantees that no tree crops are lost. Finally, the tree fruits are collected in the collecting funnel, from which they can be transferred to crates.

Once all the rods have been pulled out of the treetop, the entire harvesting head moves down three-quarters of the distance of the two rows of rods. Thereafter, the rods are driven back into the tree, and the cycle repeats. The cycle is repeated until the harvesting head extends out of the tree at the tree trunk level. A quarter or about a 90°-section of the tree is thus harvested. Clearly, such a harvesting could be done even with the picking rods rotated by 90°, in which case the harvesting rods would be offset from time to time by ¾ of their distance laterally and the vibration of the picking rods would occur not in a vertical, but in a horizontal direction or oblique to the perpendicular angle. However, after harvesting one section of the tree, the harvesting robot can approach the next quarter or 90°-section of the same tree or another. This depends essentially on the orchard structure and the way in which the trees are planted. If the tree is on slanted terrain, the harvesting robot can automatically align the harvesting head relative to the tree by means of hydraulic, pneumatic or electrical actuators. After the job is complete, the harvesting robot can be compactly folded. This makes driving through an orchard or on a street easier. In this configuration, the harvesting robot saves space when parked.

In the following section, a sample version of such a harvesting robot, i.e. a realistic construction, is presented in detail through drawings, and its means of operation is explained. FIG. 1 shows the harvesting robot as seen from the front, while entering a tree for the first time with the picking rods 3, 4 in their uppermost position. The harvesting robot has at least two parallel, protruding and offsetting rows 1, 2 of harvesting rods 3, 4 held in their rear area in a support 5 in a harvesting head 15. In the example shown, the harvesting rods are situated in two horizontal planes. The harvesting rods 3, 4 can now be pushed collectively with their free front ends 6 into a tree, with the entire body of the harvesting robot moving towards the tree trunk. For this purpose, it can be mounted on a chassis or attached to a tractor or a hangar carrier vehicle. Before the harvesting robot is driven into a tree with its harvesting rods 3, 4, it is set up on the spot with hydraulic driven, pneumatic or electric actuators, so that an inclination around the longitudinal and/or transversal direction (pitch and roll) is compensated for. For this purpose, the harvesting robot is mounted on a chassis which can be swiveled around two intersecting axes mounted on a carrier vehicle. Erecting it perpendicularly is important because, in many cases, the terrain on which the trees to be harvested are standing is inclined. Consequently, for each subsequent entry into a tree it must first be ensured that the harvesting robot is standing perpendicular. This perpendicular setting is performed automatically through sensors detecting the inclination of the harvesting robot and is erected automatically by means of the appropriate hydraulic drive or the pneumatic or electric actuators into the perpendicular setting. However, the setting can also be controlled manually through the same drives. The driving of the harvesting rods into the tree can also be done by moving the vehicle towards the tree until the harvesting rods start touching the branches of the tree. Then the vehicle stops.

Furthermore, the harvesting rods 3, 4 are then pushed with their free ends 6 into a tree through a structure built on the vehicle. This structure includes one or more hydraulic, pneumatic or electrical extension-and-retraction actuators so that entry and exit into the tree are made in the same way by means of a relative movement to the vehicle. Then the horizontally-projecting harvesting rods 3, 4 can be pivoted with their front ends 6 against each other and afterwards pivoted away from each other again. They can be pulled out of the tree as a whole during each pivoting stage via the moveable rod extractor 49 in the harvesting head 15. During this retraction, when the two rows 1, 2 are pivoted together or oscillated by harvesting rods 3, 4 and at the same time collectively pulled out of the tree, the fruits or olives or nuts are removed from their stems and are subsequently caught between the upper row 1 and lower row 2 of the harvesting rods 3, 4, or they are shaken off the stems by the swinging harvesting rods 3, 4. By opening and swiveling the harvesting rods 3, 4, the harvested fruits fall down into the collection funnel 16. The sidewalls 8 visible here, together with a rear-mounted tarp 48 or a net, guarantee that those fruits or olives that are flung back or fall aren't lost. They bounce off the insides of these walls 8 and on the tarp/net 48 and fall afterwards in the collecting funnel 16 as well. The individual harvesting rods 3, 4 of each row 1, 2 are mounted to be translationally moved to the rear area against a spring force into a support 5 on the harvesting head 15. Each picking rod 3, 4 can therefore be individually pushed back against this spring force, so that it is pushed into the frame 17. Each picking rod 3, 4 within a row 1, 2 can revert backwards, if, when brought into a tree, it hits and is stopped at the front end 6 from a branch. It is pushed into the support 5 of the harvesting head 15 against a spring force. Furthermore, the harvesting rods 3, 4 may be deflectable in all directions so that they are deflected when the tip hits an obstacle, avoiding excessive bending or breakage. In other words, if they are swiveling in a vertical direction as initially shown, then they can also swivel horizontally within a certain range, so that they can move in all directions when they hit an obstacle, in which case they can hit with the tip and can slide in a direction transverse to the direction of the harvesting rod. All harvesting rods 3, 4 that don't hit an obstacle are pushed further into the tree.

The harvesting robot is driven into a tree until the front ends 6 of the harvesting rods 3, 4 reach near to the tree trunk. Thereafter, the harvesting rods 3, 4 are actively pivoted up and down via a driving system. The spaced rows 1, 2 of harvesting rods 3, 4 can swivel and move in an oblique direction to the grid formed by them. In the example shown, this transversal direction extends vertically. Simultaneously or subsequently to pivoting together, the picking rods 3, 4 are collectively withdrawn back out of the tree, with all the picking rods 3, 4 being pulled out of the tree through the rod extractor 49 against the force of the acting springs. After adjusting the height of the picking rod rows 1, 2, the harvesting rods 3, 4 are again pushed forward relative to the harvesting head 15 on the mount 5 due to the acting spring forces and finally return to their initial position, as shown in FIG. 1. The harvesting rods 3, 4 on the harvesting robot are resiliently mounted in a range between about one-fifth and one-third of their length (between 1.50 m and 2.50 m) from their rear end 7 perpendicular to their running direction, and their rear ends 7 are driven up and down in the direction of the spring loaded suspension by a motor, so that the front ends 6 are swiveled against a larger space and so that they are resiliently supported when hitting an obstacle by the spring-mounted support in the direction of the pivot plane, as will be shown later in FIGS. 16 and 17.

The height of the harvesting head 15 on the harvesting robot is adjustable. For this purpose, scissor constructions 11 are used on both sides of the harvesting robot. These scissor structures 11 alone can serve as a guide, in that the harvesting head 15 by means of its own device is automatically adjustable in height, or the scissor structures 11 themselves form the drive for the height adjustment of the harvesting head 15 as the front and rear joints of the scissors are penetrated at one or more locations through horizontally-extending hydraulic cylinders, pneumatic cylinders or electric actuators, whose pistons are extendable so that the scissor structures 11 act as lifting shears and are movable up and down. On each side of the harvesting robot, the scissor structures 11 carry a sidewall 8, each formed by many horizontal, front, free battens 9, spaced apart from each other. These battens 9 extend from the rear end 10 to the front. Each is attached to a rear and front joint of a scissor construction 11. At their front end, they remain free to float; therefore, they form, so to speak, fingers, which are movable into the branches and twigs of a tree thanks to their free front end, to a great extent, similar to the harvesting rods 3, 4. When the scissor constructions 11 are extended to the very top, as shown in FIG. 1, gaps 12 of several centimeters form between the individual battens 9. To fill these gaps 12 as much as possible, rods 14 made of metal or a suitable plastic are arranged in these gaps 12 in order to extend parallel to the battens 9. In addition, the edges of the battens 9 may be provided with brushes, so that therefore the bristles protrude up and down at adjustable angles to the battens 9. The rods 14 are held in their rear area on hinges so that when the scissor constructions 11 move together, the parallel-running rods 14 are pivoted together through all these packs of rods, forming an arched structure designed as a hinge bracket that can swivel together, and through the swiveling of their ends they swerve into the interior of the sidewall, as displayed in FIGS. 37 and 38. Both the battens 9, and the rods 14, are spring-loaded and moveable from the back, as are the harvesting rods 3, 4, for example, through flexible straps stretched while moving backwards, and after eliminating a push-back force, the battens 9 and push rods 14 move forward again. Below the two sidewalls 8, the collecting funnel 16 can be seen, in which the harvested fruits will fall off the harvesting rods 3, 4 so that they can be further caught through a hole 18 into a crate or bag. The recess 19 within the collecting funnel 16 is provided with brushes and intended to receive the tree trunk of a tree when the harvesting robot is driven into it and driven close to the trunk. The height of this entire collecting funnel 16 can be adjusted via a hydraulic cylinder, a pneumatic cylinder or an electric actuator combined with a chain hoist. At different terrain angles on which the harvesting trees stand, the collecting funnel 16 can thus be placed at the correct height under a tree without colliding with the terrain. Otherwise, that would be the case, especially if a tree is approached from below on the sloped terrain.

FIG. 2 shows this harvesting robot from the front. The two sidewalls 8 are visible from the lateral edges of the collecting funnel 16 upwards, and in the upper region of the harvesting head 15 with the two rows 1, 2 of the harvesting rods 3, 4. In this view, the round bars 14 between the battens 9 are recognizable, almost filling up the spaces or gaps 12 between the battens 9. These round bars 14 are held at the rear end by two hinges at the front and rear end of a scissor structure 11, which is curved to a slight arch. The more the scissor structure 11 is collapsed downward, the narrower the gaps 12 between the horizontally-extending battens 9 and the more the hinges or their links are swiveled together, so that the arch 40 formed by them has an even smaller radius. Accordingly, there are visible arches forming in the drawing, where the round bars 14 correspond vertically to the sheet plane, and each forms a free finger at the front end. Overall, these sidewalls 8 can be driven into a tree at varying height settings. The free, front battens 9 and the interposed, free, front round bars 14 can be driven like fingers into the tree branch and, if necessary, due to their stiffness and flexibility, avoid a certain range of branches and twigs sideways, for which they are rounded at their free end. The longitudinal edges 13 of the battens 9 can also be provided with brushes made of elastically-yielding rods extending transversely to the battens 9 for extensive closure of the walls 8 in the upward-extended state of the scissor construction 11. If the battens 9 or round bars 14 encounter a hard obstacle, such as a strong branch which they are unable to move to the side, they behave similarly to the harvesting rods 3, 4 when hitting this obstacle in that further movement of the harvesting robot into the tree pushes them back translationally to the harvesting robot. The rods 14 and the battens 9 are translationally moveable in this way against the spring force of rubber bands. During the subsequent withdrawal of the harvesting robot from the tree, the round bars 14 and the battens 9 are pushed back to their original positions by these rubber bands. Through this free, spring movement, damage to the battens 9 and the round bars 14 is prevented.

FIG. 3 shows the harvesting robot diagonally from the front. As shown here, it is mounted on the front of a hangar carrier vehicle 20, which, at its rear, has a compressor 21 for supplying the actuators in the harvesting head 15 with compressed air. This whole unit at the rear weighs about 250 kg and serves also as a counterbalance to the front-mounted harvesting robot. The compressor 21 is driven by the rear power take-off shaft of the carrier vehicle for slanted terrain 20. The front power take-off, however, is used for the hydraulic pump of the hydraulic drives for the lifting shears, to raise the entire harvesting robot and for the height adjustment of the collecting funnel 16. The compressed air from the compressor serves on one hand to drive the pneumatic cylinder, which sets a transverse profile 37 (FIGS. 25 and 26) up and down on the harvesting head 15 in order to oscillate the picking rods 3, 4. On the other hand, the compressed air is used to operate a pneumatic or electric hoisting motor 25 (FIG. 19) and the eccentric masses at the free, front ends 6 of the harvesting rods 3, 4. Towards the rear in FIG. 3, the frame 17 can be seen, which, like a drawer, can be moved into the harvesting head 15. Within the frame 17, a variety of pneumatic tubes 55 can be seen, wound-up like a spring and thus extendable to different lengths. They can be connected to the rear end of the frame 17 via a connection with a pneumatic hose for compressed air from the compressor 21. At their front ends, they are connected to the rear ends of the picking rods 3, 4 to inject air into the interior of the tube-like shaped picking rods 3, 4. The air arriving at the front end of the harvesting rods 3, 4 causes the revolving-mounted eccentric mass to rotate so that the harvesting rods 3, 4 not only oscillate up and down but, depending on the compressed air pressure and thus the variable rotational speed of the eccentric mass rotate and move within an enveloped cone. In addition, the carrier vehicle for slanted terrain 20 with its front power take-off shaft can be used as the power source for driving an additional hydraulic pump that powers the various hydraulic cylinders of the harvesting robot. Among other things, the hydraulic cylinders serve as upward extensions of the scissor structures 11 or the lifting shears and thus for the harvesting head 15 and the sidewalls 8. From the perspective displayed, the horizontal battens 9 of the sidewalls 8 and the likewise horizontally-extending round bars 14 can also be seen. So that the harvested olives cannot fall back against the tractor, a roller 47 with a tarp 48 or a net is installed. When driving up the harvesting head 15, the tarp 48 or the net of the spring-loaded roller 47 is unrolled so the tarp 48 or the net roll up due to the spring when the scissor structures 11 move together. The tarp 48 or net forms a wall in their unrolled states, preventing the olives from falling backwards. As an alternative to a tarp 48 or net, extensible fins would also be possible, similar to shutter slats. However, all the functions described above can alternatively be operated by a hydraulic or electric motor. The power take-off shaft drives either a hydraulic pump or for pneumatic functions, a compressor for providing compressed air in a separate pressure vessel on the harvesting robot. While using electric drives, the vehicle battery can be used as an energy source, and if this is not enough, the power take-off shaft can drive a generator belonging to the harvesting robot, charging a separate battery of appropriate capacity.

FIG. 4 shows a view of the harvesting robot diagonally from the front, with the harvesting robot collapsed downward. From the position of the harvesting robot as shown in FIG. 3, with a fully upward-extending harvesting head 15, the two rows 1, 2 of harvesting rods 3, 4 are driven into a tree and moved backward while oscillating against each other using an extractor 49 (FIG. 5), not visible here. The harvesting rods strip and shake the fruits from the tree, and they fall into the collecting funnel 16. The backwards motion will be continued until the harvesting rods 3, 4 have moved all the way out of the tree, then the harvesting head 15 is driven downwards by about ¾ of the distance between the two rows 1, 2 of the harvesting rods 3, 4, and they are moved in and out again into the tree under oscillation, etc., until the whole harvesting robot presents itself as shown in FIG. 4. The scissor structures 11 are now moved completely down and the battens 9 lie almost or entirely on each other. The two rows 1, 2 of the harvesting rods 3, 4 are in their lowermost position to be driven out from a tree. In this assembled position of the harvesting robot, with drawer-like head frames 17 pushed forward into the harvesting robot, the hangar carrier vehicle 20 can also be driven on a public road, because the harvesting robot can be designed, for example, to a width of 2.50 m, so that no excess width is needed. For the harvesting of larger trees, however, it can of course be wider, which would then require an exemption permit for driving on public roads.

FIG. 5 shows a view of the harvesting robot seen diagonally from above and towards the rear. As can be seen, on each side of the harvesting robot, there are two scissor constructions 11 built, each as lifting shears on the support frame 21 of the harvesting robot, between which the rear ends of the sidewalls 8 extend. The backward-projecting frame 17 is similar to a drawer that can be manually moved forward. The frame 17 forms the intake for the guide 50, which leads the rod extractor 49 when pulling out the rows 1, 2 of the harvesting rods 3, 4 to the rear. The rod extractor 49 is operated by means of a cable 22, which runs at the rear end of the frame 17 via two pulleys 23, 24 and is preferably driven by a pneumatic drive motor 25, also with a pulley. Hydraulic or electric drive solutions are possible as well. This frame 17, while driving the two rows 1, 2 of harvesting rods into a tree, takes on these pushed-back picking rods 3, 4. These are then pushed back against a spring force into the frame 17. To harvest the fruits trapped between or struck by the harvesting rods 3, 4 or the fruits stripped and fallen down, the harvesting rods 3, 4 are extracted while superimposing the oscillation and rotary motion of the rods 3, 4, by the rod extractor 49 into the frame 17 against acting spring forces, until completely withdrawn and therefore within the frame 17. Then, the harvesting head 15 is slightly moved and the rod extractor 49 moves forward again, whereby the picking rods 3, 4, pushed by the force of the effective springs, are pushed forward into the tree, and then the oscillation and rotation of the harvesting rods 3, 4 is initiated again.

FIG. 6 shows the harvesting robot in a view from above the plan. On the left side of the drawing, the harvesting rods 3 of the upper row 1 can be seen, with the laterally-delimiting sidewalls 8 above the collecting funnel 16 and the outer scissor structure 11. In the middle, there is the harvesting head 15, where the harvesting rods 3, 4 are held. On the right, the frame 17 is shown, over which the pneumatic tubes 55 extend to supply the harvesting rods 3, 4 with compressed air.

FIG. 7 shows another view of the harvesting robot diagonally from the front and top with the left side wall and all picking rods missing except for two, namely a harvesting rod 3 from the upper row 1 and a harvesting rod 4 from the lower row 2, while the remaining harvesting rods are hidden. Whenever a single harvesting rod 3, 4 is facing strong resistance, such as when it meets with a thick branch at its front end, it will be pushed into its holder in the harvesting head 15 against the force of a spring to the rear and thus into the frame 17 as far as necessary depending on the situation. It may therefore be that after driving the harvesting robot into a tree, a few harvesting rods 3, 4 are more or less pushed back into the frame 17. The sidewalls 8, or the battens 9 and round bars 14, are rounded in front and flexible in each direction, but still relatively stiff. They deviate from the same angle when hitting an obstacle, either because they bend sideways immediately due to their flexibility or, because of their stability; they first push something out of the way in the form of a branch or twigs and then slide off that branch or those twigs. The battens 9 and round bars 14 of the sidewall 8 can be pushed back by an obstacle such as a thick branch, similarly to the harvesting rods 3, 4. The battens 9 and round bars 14 of the sidewalls 8 are spring-loaded by means of rubber bands and return to their initial position as soon as they can spring back in the absence of resistance. Below the drawing in FIG. 8, the circular section A of FIG. 7 is further enlarged, and you can see how the drive 26 for the scissor structure 11 is attached on the other side of the harvesting robot. In a horizontal square tube 27, another smaller square tube 28 is movably-mounted. At its upwardly-projecting tabs 29, the lowermost scissor struts can be pivotably-mounted, and at the other, opposite end of the stationary square tube 27, the associated scissor struts can then also be pivotably-mounted, which crosses the above-mentioned via a common axis. By the extension and retraction of the smaller square tube 28 into the large square tube 27, for example, by means of a hydraulic or pneumatic-threaded rod, the scissor structures 11 can be extended upwards and retracted again. On the rear side of the harvesting head 15 the frame 17 can be seen in FIG. 7, within which the tension-spring, extendable pneumatic tubes 55 are housed, which are supplied by the compressor 21 with compressed air to drive the eccentric mass on the tips of the picking rods 3, 4. FIG. 9 shows the detail B in an enlarged view in FIG. 7, namely a view perpendicular to the left side of the vehicle with its elements for holding, height adjustment and lateral pivoting of the entire docked robot. In FIG. 10 the robot is presented in a diagonal view from the front in a retracted position, that is, with withdrawn picking rods and in FIG. 11 it is seen diagonally from behind.

FIG. 12 shows the harvesting robot in action on sloping terrain. It is shown here how it approaches the tree to be harvested from below on a slope. FIG. 13 shows the harvesting robot with a view of its right side while approaching a tree to be harvested from above on a slope. FIG. 14 shows a front view of the harvesting robot approaching a tree (not shown) from a isoline curve on a slope, and FIG. 15 shows it on horizontal ground, whereby the harvesting head and all its elements are tilted laterally facing the vehicle. The robot is pivotable on the vehicle to the front and rear as well as to the left and right by an angle of about 20° to 30°.

In FIG. 16, the harvesting robot is shown as in FIG. 3, but with the harvesting rods 3, 4 pulled backwards. The entire space between the two sidewalls 8 therefore remains free and offers an unobstructed view of the rolled-up tarp 48, closing the space between the sidewalls 8 at the rear.

In FIG. 17, the harvesting head of the harvesting robot, as in FIG. 16, is shown in a magnified view, with the harvesting rods 3, 4 pulled out to the rear. By means of the pneumatic drive 25 with a pulley as well as the attached cable 22, the rod extractor 49 can be moved forward again and thus pushes the harvesting rods 3, 4 into their operational position.

This entire harvesting head in FIG. 18 is shown diagonally in an even more enlarged view from behind and the top. One can see the pulled-back harvesting rods 3, 4 with their rod extractor 49, which is movable forward with the cable 22, taken along with the harvesting rods 3, 4, as well as the frames 17, in which the rod extractor 49 and the harvesting rods 3, 4 are guided.

As an alternative to an attachment to a tractor or carrier vehicle for slanted terrain 20, this robot can also be fitted with its own chassis. As such a chassis is suitable on one hand for drive tracks for gentle ground and off-road driving, or an all-wheel drive with four or more wheels. A support on the chassis, swingable on all sides, permits the harvesting robot to always be in an upright position on the chassis and to be held tight in this position. In FIG. 19, the harvesting robot is shown constructed on its own chassis 54, presented from a side view, with a view of its left side. The harvesting head is extended to its uppermost position, in which the scissor structures 11 have hoisted it up. The chassis 54 is equipped with four wheels, which are, in this example, all drivable. For this purpose, one electric drive can be provided for each individual wheel. The front and rear wheels can be steered for maximum maneuverability of the harvesting robot between the trees of an olive grove. Such a harvesting robot is operated through a wireless remote control. The operator stands or sits next to it and can control and monitor all operations via a portable control panel or joystick. A self-directed and controlled harvesting robot version can be positioned on the terrain where the trees are located by differential GPS or by reference sensors attached to the trees. Through a harvesting robotic network, the robots communicate to divide the workload. For example, up to four harvesting robots can harvest their 90° sector of one tree at the same time.

FIG. 20 shows this harvesting robot with its own chassis 54, whereby the harvesting head 15 is moved into its lowest position. In this position, the harvesting robot is transportable, in that, for example, it can be driven onto a trailer with a deep cargo bed or lifted onto a truck.

FIG. 21 shows the harvesting robot behind a designated olive tree driving into it towards the viewer. If the harvesting robot is moved in this way towards the tree as well as its branches and twigs, the cavity of the collecting funnel 16 surrounds the tree trunk. One can see here the collecting funnel 16 and the two wheels 30 of the tractor or the carrier vehicle for slanted terrain. The two rows 1, 2 of the harvesting rods 3, 4 here have been extended upwards into their uppermost position. The two sidewalls 8 are driven with their battens and the round bars between the battens into the tree. Now, a first harvesting may begin, in that the picking rods 3, 4 are swung up and down and in circles, and at the same time are being pulled out of the tree by collectively retracting the rod extractor 49. To the right of the drawing in FIG. 22, an enlarged detail A from FIG. 21 is shown, displaying the harvesting head 15. One recognizes the front ends of the upper row 1 of the harvesting rods 3, and each of the lower rows 2 of the harvesting rods 4.

FIG. 23, under the enlarged circular section A, shows two harvesting rods 3, 4 from the side. The upper harvesting rod 3 is stuck on a branch fork, while the lower harvesting rod 4 got stuck earlier in a branch fork and was thus shifted backwards in relation to the upper harvesting rod 3 when driving further into the tree.

FIG. 24 shows a view of the ends of the harvesting rods from the front. One recognizes the upper row 1 and lower row 2 and, when a little enlarged, shows the fruits or olives between the two rows 1, 2, and to the right of it, how they are torn from their stems due to the vibration of the harvesting rods 3, 4 and fall.

With reference to FIG. 25, the holding support and mounting of the harvesting rods 3, 4 on the harvesting head 15 is presented in greater detail. At the rear end, the harvesting rods 3, 4 are fitted into a socket 35, 36. These sockets 35, 36 are connected to vertical rods, moving up and down. For this purpose, the profile 37 moves up and down through a pneumatic actuator. The pivotal struts 38 on the harvesting head 15 transmit the up-and-down movement to the lower profile 51. The ends of the harvesting rods 3, 4 are thus moved up and down synchronously opposite to each other. The rod holders arranged further forward with their sockets 33, 34 are designed to be vertically resilient, that is to say they are fastened to the spring struts 31, 32 so that the sockets 33, 34 can yield up and down. If the rear sockets 35, 36 are then moved up and down with pneumatic or electrical forces, the front sections of the harvesting rods 3, 4 also follow, doing so from their spring-mounted sockets 33, 34. But if the front portion of a picking rod should encounter a hard obstacle when rotating, this resilient assembly in the sockets 33, 34 offers a failback so that the harvesting rods 3, 4 are not damaged.

FIG. 26 shows the situation when the two ends of the harvesting rods 3, 4 have been moved completely against each other and encounter an obstacle. The actuation profile 37 has accordingly reached its uppermost position. So that the harvesting rods 3, 4 do not bend, the socket 33, 34 is deflected vertically against a spring force. Accordingly, the front portions of the picking rods 3, 4, i.e. those in front of the sockets 33, 34, are pivoted together so that the front ends of the staggered harvesting rods 3, 4 are pressed together on the obstacle. The effect of the harvesting rods 3, 4 on the obstacle is like the effect of grasping forceps. All this movement and deflection applies to all harvesting rods 3, 4 of the upper and lower rows 1, 2.

FIG. 27 shows the harvesting head 15 in a diagonal view from above and to the rear, with a variety of longitudinally-moveable harvesting rods 3, 4, with the frame 17 and the cable pull 22, for pulling out the rod extractor 49 by means of the drive 25. In FIG. 28 one can also see the harvesting head 15 from above.

In addition, in FIG. 29, one can see a side view of the section along the line A-A of FIG. 28 with the harvesting head 15, the forward-projecting harvesting rods 3, 4 and the backward-projecting frame 17 with its cable 22 and drive 25. The scissor structure 11 is completely collapsed here, so that the harvesting rods 3, 4 are in the lowest position. The detail A at the front tip of the lower picking rod 4, as shown in FIG. 30, is interesting. The tip of the harvesting rod 4 carries an eccentric mass 39, which is rotatable about the rod axis. For this purpose, this harvesting rod is a tube 41. Within it, compressed air can be conveyed to its tip, which can then further rotate the eccentric frontal mass 39 mounted on the rod tip. When it rotates, this leads to an all-around oscillation of the harvesting rod 4. Depending on the air pressure and the resonance frequency of the harvesting rod 4, a soft, wide oscillation can be generated up to an almost local, fine vibration of the eccentric mass 39. Via the superimposition of the two oscillations, the rotation and the up and down movement should allow the rod tip to pass all spatial points in the area around the rod tip and thus achieve better harvesting results. Under the detail A in FIG. 31, the detail B in FIG. 29 is presented, which is also derived again from section A-A of FIG. 29. Here, one can see in detail the suspension of the harvesting rods 3, 4 through a rubber strap 52 which is attached to the harvesting head 15 and connected via pulleys 53 with the end of the harvesting rods 3, 4. Further recognizable are the sockets 34, 36 of the picking rod 4. The detail C in FIG. 32 is also taken from the section A-A of FIG. 29 and shows the rear, lower corner of the frame 17 with the deflection pulley 24 set up there for the cable 22. Further to be seen are the two pneumatic hoses 42 and the pneumatic connections 43 for supplying the pneumatically operated imbalance mechanism at the end of the harvesting rod 6.

FIG. 33 shows the harvesting head 15 with the large number of longitudinally moveable harvesting rods 3, 4 and their suspensions seen in a front view, and below in FIG. 34 a circular section of detail D of FIG. 33 in an enlarged view. One can recognize the struts 31 for the upper row of harvesting rods 3 and the lower struts 32 for the lower row of harvesting rods 4, and in FIG. 33, the two scissor structures arranged parallel to each other 11.

FIG. 35 shows the left side wall 8 of the harvesting robot in the upwardly-extended state, looking at its inside. It consists of a number of free battens 9 and, between the battens, several round bars 14 for driving into the tree branch. These battens 9 and round bars 14 can yield elastically on all sides. The side walls 8 prevent the fruits or olives or nuts, which at the most will fly sideways due to the vibrations of the picking rods 3, 4, from falling to the ground and going to waste. Rather, they are most likely seized by the battens 9 or round bars 14 and will afterwards fall into the collecting funnel 16. At the rear end of the sidewall 8, there are scissor structures 11, two for each sidewall 8. The battens 9 and the round bars 14 extend over this scissor structure 11 away to the rear and, like the harvesting rods 3, 4, can be pushed back longitudinally against a spring force.

FIG. 36 shows a view of the round bars 14 in the region of the scissor structure 11. These round bars 14 can run between two scissor structures 11, so that only the outer scissor structure 11 behind the round bars 14 is recognized here. The round bars 14 are connected through transversely-extending hinge plates. As the two outer ends of the hinge plates move toward each other, they further register the round bars 14 against the interior of the sidewall 8 so that the radius of the curve formed is reduced.

In reference to FIG. 37, the arrangement of the round bars 14 in these hinges or hinge plates 45 offers a better understanding. A detail of a section through a sidewall 8 is shown. The hinges or hinge plates 45 here consist of four interconnected, hinge links 46, wherein the round bars 14 are perpendicular to the hinges 45 and attached to the extending hinge points. As shown in FIG. 38, it will now be shown how, when the scissor constructions 11 have collapsed all the way down and the distances between the battens 9 have become minimal, the wrist straps 45 with their four links 46 are fully swiveled together, as shown. The round bars 14 then form a curve against the inside and an impenetrable grid of horizontally spaced bars 14 for the fruits. Finally, FIG. 39 shows all parts of the described structure in an exploded view. Through this exploded view, more details are visible, and it shows how these parts work together. All drives used for the various functions of the harvesting robot are, in principle, hydraulic, pneumatic or electric drive solutions, depending on the particular vantage point. For the extension of the harvesting rods, a pneumatic variant will probably be advantageous, and for the alignment of the entire harvesting robot, the answer is probably a hydraulic solution, while for the oscillation of the harvesting rods, an electric or pneumatic solution may apply.

Finally, FIG. 40 shows in a top-down view how a group of four dense olive trees can be harvested as part of a double row of olive trees. The individual olive trees have a ground level radius of 2.5 m. For this purpose, the robot or its harvesting head 15 is mounted in a pivotable position on a rotary disk 56 about its vertical axis 59. This rotary disk has its own chassis 57, which can be coupled via a tow bar construction 58 to a tractor or a carrier vehicle for slanted terrain 20. First, the vehicle is aimed precisely at the common center of the four trees, and at the same time, as soon as the harvesting head 15 moves into the central area between the trees, this harvesting head 15 is pivoted to the right about the vertical axis 59, as shown. The harvesting rods 1-4 protrude into the rear of the harvesting head 15. In the next step, the picking rods 1-4 are advancing towards the tree trunk, as shown in FIG. 41. The harvesting rods 1-4 then start oscillating and are withdrawn, while the fruits, here the olives, descend and are collected. Afterwards, for example, the harvesting head is swiveled 45° to the left. For this purpose, the tractor 20 must be moved back a bit and then driven forward again. The harvesting rods are then halfway into the tree at the back right and half pushed into the tree at the back left and these areas are harvested. The harvesting head is then swung to the left after the tractor moves slightly 45° to the left, so that the same situation results as shown in FIG. 40, but now adjacent to the tree from the back left. The picking rods 1-4 are driven in again and the olives are harvested. The tractor can then leave and do the same from another side of the group of trees. Each time, the interior sectors 60 of the trees are harvested. The outer areas of the trees are, however, harvested in the conventional manner as described earlier. All in all, in this manner, it is possible to harvest the entire tree efficiently, even for trees within tight distances.

FIG. 42 shows a group of four trees, each within a 2.5 m radius of a single tree, and the method of harvesting is further applied, whereby here the harvesting head moves successively into several sectors, namely on the radials A, B, C, D, E, F and G. The robot starts, for example, with the tree on the front-left and drives the harvesting head on the radial A into the tree, and will further harvest this area. Afterwards, the harvesting head is seen after moving out of the tree at ground level to the right, pivoted clockwise and then moves the harvesting head on the Radial B between the two trees on the left side in the image and harvests this area, then on Radial C, then on Radial D, etc. In this sequence, it doesn't matter whether starting left or right, the process will be the fastest to implement to harvest this inner sector. The remaining areas can be harvested from the outside area. This process increases efficiency by reducing the repositioning time of the robot by up to 50%. This method should be used to have an average harvesting time of 5 minutes per tree. However, this solution will not be possible on every slope. In this case, the procedure can be changed to the one shown in FIGS. 12 to 14. Depending on the slope of the terrain and frequency of distance between trees, one or the other harvesting strategy can be followed. These two strategies can complement each other.

The trees in most olive groves are planted with measuring equipment, so that the pattern deviations are small, as in the displayed example, within a basic square area of 5×5 m enclosing the four trees. The trees can also be provided with sensors that can communicate with the robot and provide specific position data about location. The sensors are like the chips implanted, for example, in dogs or wild animals, so that their location can be monitored at any time. From all this specific data, the complete information about a tree can be selected, for example its exact position, altitude, sector division etc. The tree sensors can take on the task of a GPS and have the effect of a Non Direction Beacon (NDB) or a VHF Omnidirectional Range (VOR) analogous to those used in the aviation industry. When each tree is equipped with such a sensor, the robot then finally operates in a known matrix. The GPS becomes redundant in this case. Plus, there is an additional market and thus an additional source of income through the sale of these sensors, which will then be required in large quantities.

### LIST OF NUMBERS

1 Upper row of harvesting rods 3

2 Lower row of harvesting rods 4

3 Upper harvesting rods

4 Lower harvesting rods

5 Mount

6 Free front ends of the harvesting rods

7 Rear end of the harvesting rods

8 Limiting sidewalls

9 Front free battens

10 Rear end of the battens 9

11 Scissor construction

12 Space between the battens

13 Longitudinal edges of the battens

14 Bars between the battens 9

15 Harvesting head

16 Catching funnel

17 Frame for receiving the rear ends of the harvesting rods 3,4

18 Hole in the catching funnel

19 Recess in the catching funnel

20 Carrier vehicle for slanted terrain 20

21 Counterweight to the harvesting robot

22 Cable pull for frame 17

23 Deflection pulley 22

24 Deflection pulley

25 Drive for cable pull 22

26 Scissor construction drive 11

27 Square profile

28 Smaller square profile, sliding in 27

29 Flaps

30 Wheels of the carrier vehicle for slanted terrain

31 Strut for harvesting rod 3

32 Strut for harvesting rod 4

33 Socket on strut 31 for harvesting rod 3

34 Socket on strut 32 for harvesting rod 4

35 Socket on the back of harvesting rod 3

36 Socket at the back of harvesting rod 4

37 Actuation profile for the vibration of harvesting rod 3

38 Swivel struts for actuation profile

39 Eccentric imbalance

40 Bow of the wristbands

41 Pipe as picking rod

42 Pneumatic hose for imbalance mass

43 Pneumatic connection to the valve box

44 Rear profile of the frame 17

45 Wrist strap/wrist flap

46 Hinge links

47 Roll for the tarp

48 Tarp or net for the rear of the harvesting robot

49 Rod extractor

50 Guide

51 Lower profile

52 Elastic strap

53 Pulleys

54 Chassis of automotive harvesting robot

55 Spring-extendable pneumatic hoses in frame 17

56 Rotary plate for tilting the harvesting head

57 Chassis for rotary plate

58 Tow bar construction of the carrier vehicle

59 Vertical axis about which the harvesting head is pivotable.

1.-15. (canceled)

16. A harvesting robot for picking fruit from trees comprising at least two mutually parallel extending, protruding and offsetting rows of picking rods that are held in their rear area in a support and collectively with their free, front ends are able to slide into a tree and, with their front ends against each other, are pivotable and to be open again, and collectively can be pulled out in its entirety in every pivoted state of the tree, for picking fruits between the harvesting rods with the two rows of harvesting rods;
the individual harvesting rods of each row mounted in the support so as to be translationally moveable against a spring force in their rear region, so that each harvesting rod within a row during the insertion of the harvesting rods into a tree, when striking its front end on a branch, is stoppable by the same, while harvesting rods able to avoid an obstacle can be moved further into the tree, after which the harvesting rods of the two rows can be swiveled against each other in their current translational position, and at the same time or subsequently can be pulled out of the tree through the rod extractor, whereby all harvesting rods are pushed forward through spring forces and thus can be brought into their original position.

17. The harvesting robot for picking tree fruits according to claim 16, wherein at the front tip of the harvesting rods a rotatable eccentric mass is mounted about the longitudinal axis of each one of the harvesting rods which is rotatable via the harvesting rods formed as a tube by means of compressed air or an electric drive so that the tips of the harvesting rods are moveable during the up and down into a superimposed oscillations and, with their tips, would brush an area around the tips while at rest and depending on the rotational speed of the eccentric mass can be moved in a superimposed oscillation.

18. The harvesting robot for picking fruits from the trees according to claim 17, wherein on the back of the harvesting head there is a frame mounted in a drawer-like manner, that is retractable to the rear and housing the harvesting rods that were pushed back by encountering obstacles when driving into the tree with the same, and, that at the rear end of the frame, pneumatic connections are provided, for connection to the rear ends of resiliently-extendable pneumatic tubes, which are connected with their front end to the rear ends of the harvesting rods for supplying the rotatable eccentric mass at their front ends with compressed air for their drive.

19. The harvesting robot for picking fruit from trees according to claim 16, wherein the harvesting rods mounted on the harvesting robot are resiliently mounted perpendicular to their longitudinal direction between one-fifth and one-third of their length from their rear end that is motor-driven back and forth in the direction of the spring force so that the front ends are swiveled by a greater displacement than the rear ends and are resiliently supported in direction of their oscillating plane when hitting an obstacle, and wherein the harvesting rods are mounted in a deflectable manner in all directions so that they yield if their tip hits an obstacle, avoiding excessive bending or breakage.

20. The harvesting robot for picking fruit from trees according to claim 16, wherein the free front ends of the harvesting rods are slideable into a tree, in that they belong to a structure, which is mounted on a vehicle and thus can be pushed into the tree by driving the vehicle, or that the structure on the vehicle includes one or more hydraulically, pneumatically or electrically driven extension and retraction actuators, so that the entry and exit into the tree by the same takes place through a relative movement compared to the vehicle.

21. The harvesting robot for picking fruit from trees according to claim 16, wherein the spaced rows of harvesting rods are mounted in a moveable manner on the harvesting robot transversely to the grid formed by the harvesting rods by the harvesting head of the harvesting robot, in which the harvesting rods are mounted and that is hydraulically or electrically driven by a scissor structure with an adjustable height.

22. The harvesting robot for picking fruits from the trees according to claim 16, wherein the rows of harvesting rods on the harvesting robot are arranged between two of these rows at their two-sided end barrier walls, containing a majority in the same direction as the harvesting rods spaced apart and front free battens, which are held at their rear ends on an extendable scissor structure, whereby these battens each form a slatted frame as a wall, and, within these two walls, the harvesting rod rows are moveable in a motor-driven manner longitudinally to the grid of the rows, wherein the battens can be extended transversal in relation to the extension of one of the scissor structures in a collapsed state with minimum lateral spacing of the battens, with uniform widening of their distances when extending, to each form of a slatted frame as a sidewall, where each of the battens leaves a gap.

23. The harvesting robot for picking fruits from the trees according to claim 22, wherein the longitudinal edges of adjacent battens are connected in their rear region to at least one articulated support, in which a plurality of rods are held parallel to the battens so that the distances between the rods by retracting or extending the battens are variable, and the rods and battens with their free ends in each extended position of the battens are moving within a tree, and, with sufficient resistance, both the battens and the rods are slideable in their mounts against the force of springs to the rear.

24. The harvesting robot for picking fruit from trees according to claim 22, wherein the longitudinal edges of the battens are provided with brushes of elastically yielding rods that extend transversal to the battens, to largely close the walls while in extended state.

25. The harvesting robot for picking fruits from trees according to claim 16, wherein the spaced rows of the harvesting rods extend horizontally and are delimited on both sides by slatted, frame-like, vertically extending walls, within which they are mounted in a manner to be moveable upwards and downwards.

26. The harvesting robot for picking fruit from trees according to claim 16, wherein the spaced rows of the harvesting rods run perpendicularly and are delimited on both sides by slatted, frame-like, horizontal walls, within which they are mounted in a manner to be moveable back and forth, sideways.

27. The harvesting robot for picking fruit from trees according to claim 16, wherein the robot can be connected with a power take-off carrier vehicle for slanted terrain with power take-off shafts, by means of which the harvesting robot can be transported and operated, and by means of which the power take-off shaft can drive the associated compressor, and on the other hand, can drive the associated hydraulic pump for the hydraulic drives on the harvesting robot, wherein the harvesting robot is moveable into a tree and again able to be retracted by forward or backward driving of the hangar carrier vehicle.

28. The harvesting robot for picking fruits from trees according to claim 16, wherein the robot is on a separate chassis constructed with drive wheels or wheels with four-wheel drive, so that it is self-propelled, wherein it has a universally pivotable support on which it is consistently able to be brought into and held in an upright position on the chassis where the harvesting robot can be remotely controlled via radio through a control device or can be operated independently or integrated into a harvesting robot network for the distribution of available work, wherein the positioning of the harvesting robot relative to the tree is feasible through a GPS device with differential GPS, or with the aid of a position sensor fixed on the tree.

29. The harvesting robot for picking fruit from trees according to claim 16, wherein the robot is equipped with inclination sensors for determining its inclination or deviation from the perpendicular in each direction (pitch and roll), and that it has a control unit automatically processing the signals of the inclination sensors through the hydraulic drive, and that the height of its collecting container is adjustable by motor, and that the distances between the two rows of harvesting rods the height of the collecting container and the distances of the battens of the sidewalls can be changed and adjusted by means of separate hydraulic, pneumatic or electric drives.

30. The harvesting robot for picking fruit from trees, according to claim 16, wherein the harvesting head is mounted in a pivotal manner about its vertical axis on a rotary plate with a separate chassis, and this chassis is connectable via a towbar construction with a tractor or carrier vehicle for slanted terrain, so the harvesting head on the rotary plate is pivotable around its vertical axis by at least 90°, and that the harvesting robot has transmitters for reading the information sent through sensors on the trees, meant to calculate its position and direction of movement relative to a particular tree.
